(19) United States
(12) Patent Application Publication
(10) Pub. No.: US 2026/0371342 A1
(43) Pub. Date: Nov. 19, 2026

(54) RATE MATCHING ACROSS REPETITIONS FOR PHASE JUMP ESTIMATION ACROSS GAPS

(71) Applicant: QUALCOMM Incorporated, San Diego, CA (US)

(72) Inventors: Chih-Hao LIU, San Diego, CA (US); Jing JIANG, San Diego, CA (US); Jing SUN, San Diego, CA (US)

(21) Appl. No.: 19/207,264

(22) Filed: May 13, 2025

(51) Int. Cl. H04W 72/1268; H04L 1/00; H04L 1/08; H04W 72/232

(52) U.S. Cl. CPC H04W 72/1268; H04L 1/0013; H04L 1/08; H04W 72/232

(57) ABSTRACT

This disclosure provides methods, components, devices and systems for rate matching across repetitions for phase jump estimation across gaps. For example, a wireless communication device operating according to a coverage enhancement mode may be scheduled transmit repetitions of a shared channel message via resources that are separated in time by a gap such that phase continuity cannot be maintained. The wireless communication device may perform at least partial rate matching across resources scheduled for the repetitions, such that the repetitions of the shared channel message are at least partially in accordance with a same redundancy version. A receiver may estimate a phase jump between the repetitions by comparing the same tones and data symbols of the repetitions.

### TECHNICAL FIELD

This disclosure relates generally to wireless communication, and more specifically to systems, devices, methods, and techniques associated with rate matching across repetitions for phase jump estimation across gaps.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

In some wireless communication systems, wireless communication devices may be configured to operate according to a coverage enhancement mode to improve communication performance. For example, when configured for the coverage enhancement mode, a user equipment (UE) may be scheduled for repeated uplink shared channel transmission over multiple segments of contiguous symbols to extend uplink shared channel coverage. In some cases, a network entity may schedule the UE using a long start and length indicator value (SLIV), which may allocate a shared channel resource across a slot boundary. If the network entity schedules the UE for shared channel repetition using a long SLIV, the UE may be scheduled to communicate (for example, transmit and/or receive) multiple repetitions of a message via non-contiguous shared channel resources. The non-contiguous shared channel resources may have gaps of intermediate symbols between two shared channel resources. For example, the UE may be scheduled to transmit repetitions of an uplink shared channel transmission using a set of uplink shared channel resources, and uplink shared channel resources of the set of uplink shared channel resources may be separated in time by downlink shared channel resources. A gap between non-contiguous shared channel resources may introduce a phase jump, which may reduce decoding performance at a wireless communication device receiving the repetitions, among other challenges.

### SUMMARY

The systems, methods, and devices of this disclosure each have several innovative aspects, no single one of which is solely responsible for the desirable attributes disclosed herein. The following is a summary of some non-limiting aspects of the disclosure:

One innovative aspect of the subject matter described in this disclosure can be implemented in a method for wireless communications by a user equipment (UE) is described. The method may include receiving downlink control information (DCI) including a start and length indicator value (SLIV) that schedules a first set of multiple shared channel resources for repetitions of a shared channel message in accordance with a coverage enhancement mode, the first set of multiple shared channel resources spanning one or more slot boundaries and including at least a first shared channel resource and a second shared channel resource, the first shared channel resource separated from the second shared channel resource by a second set of multiple shared channel resources, communicating a first repetition of the shared channel message via the first shared channel resource of the first set of multiple shared channel resources in accordance with a first redundancy version, and communicating a second repetition of the shared channel message via the second shared channel resource of the first set of multiple shared channel resources in accordance with at least a partial rate matching of the first repetition to the second shared channel resource.

Another innovative aspect of the subject matter described in this disclosure can be implemented in a UE for wireless communications is described. The UE may include a processing system that includes processor circuitry and memory circuitry that stores code. The processing system may be configured to cause the UE to receive DCI including a SLIV that schedules a first set of multiple shared channel resources for repetitions of a shared channel message in accordance with a coverage enhancement mode, the first set of multiple shared channel resources spanning one or more slot boundaries and including at least a first shared channel resource and a second shared channel resource, the first shared channel resource separated from the second shared channel resource by a second set of multiple shared channel resources, communicate a first repetition of the shared channel message via the first shared channel resource of the first set of multiple shared channel resources in accordance with a first redundancy version, and communicate a second repetition of the shared channel message via the second shared channel resource of the first set of multiple shared channel resources in accordance with at least a partial rate matching of the first repetition to the second shared channel resource.

Another innovative aspect of the subject matter described in this disclosure can be implemented in a UE for wireless communications is described. The UE may include means for receiving DCI including a SLIV that schedules a first set of multiple shared channel resources for repetitions of a shared channel message in accordance with a coverage enhancement mode, the first set of multiple shared channel resources spanning one or more slot boundaries and including at least a first shared channel resource and a second shared channel resource, the first shared channel resource separated from the second shared channel resource by a second set of multiple shared channel resources, means for communicating a first repetition of the shared channel message via the first shared channel resource of the first set of multiple shared channel resources in accordance with a first redundancy version, and means for communicating a second repetition of the shared channel message via the second shared channel resource of the first set of multiple shared channel resources in accordance with at least a partial rate matching of the first repetition to the second shared channel resource.

Another innovative aspect of the subject matter described in this disclosure can be implemented in a non-transitory computer-readable medium storing code for wireless communications is described. The code may include instructions executable by one or more processors to receive DCI including a SLIV that schedules a first set of multiple shared channel resources for repetitions of a shared channel message in accordance with a coverage enhancement mode, the first set of multiple shared channel resources spanning one or more slot boundaries and including at least a first shared channel resource and a second shared channel resource, the first shared channel resource separated from the second shared channel resource by a second set of multiple shared channel resources, communicate a first repetition of the shared channel message via the first shared channel resource of the first set of multiple shared channel resources in accordance with a first redundancy version, and communicate a second repetition of the shared channel message via the second shared channel resource of the first set of multiple shared channel resources in accordance with at least a partial rate matching of the first repetition to the second shared channel resource.

In some examples of the method, UEs, and non-transitory computer-readable medium described herein, the first repetition of the shared channel message may be rate matched to the second shared channel resource of the first set of multiple shared channel resources, and the second repetition of the shared channel message may be in accordance with the first redundancy version.

In some examples of the method, UEs, and non-transitory computer-readable medium described herein, a portion of the first repetition of the shared channel message may be rate matched to a beginning portion of the second shared channel resource that corresponds to bit indexes for system bit priority mapping information, and the second repetition of the shared channel message may be in accordance with a second redundancy version that may be different than the first redundancy version.

Another innovative aspect of the subject matter described in this disclosure can be implemented in a method for wireless communications by a network entity is described. The method may include transmitting DCI including a SLIV that schedules a first set of multiple shared channel resources for repetitions of a shared channel message in accordance with a coverage enhancement mode, the first set of multiple shared channel resources spanning one or more slot boundaries and including at least a first shared channel resource and a second shared channel resource, the first shared channel resource separated from the second shared channel resource by a second set of multiple shared channel resources, communicating a first repetition of the shared channel message via the first shared channel resource of the first set of multiple shared channel resources in accordance with a first redundancy version, and communicating a second repetition of the shared channel message via the second shared channel resource of the first set of multiple shared channel resources in accordance with at least a partial rate matching of the first repetition to the second shared channel resource.

Another innovative aspect of the subject matter described in this disclosure can be implemented in a network entity for wireless communications is described. The network entity may include a processing system that includes processor circuitry and memory circuitry that stores code. The processing system may be configured to cause the network entity to transmit DCI including a SLIV that schedules a first set of multiple shared channel resources for repetitions of a shared channel message in accordance with a coverage enhancement mode, the first set of multiple shared channel resources spanning one or more slot boundaries and including at least a first shared channel resource and a second shared channel resource, the first shared channel resource separated from the second shared channel resource by a second set of multiple shared channel resources, communicate a first repetition of the shared channel message via the first shared channel resource of the first set of multiple shared channel resources in accordance with a first redundancy version, and communicate a second repetition of the shared channel message via the second shared channel resource of the first set of multiple shared channel resources in accordance with at least a partial rate matching of the first repetition to the second shared channel resource.

Another innovative aspect of the subject matter described in this disclosure can be implemented in a network entity for wireless communications is described. The network entity may include means for transmitting DCI including a SLIV that schedules a first set of multiple shared channel resources for repetitions of a shared channel message in accordance with a coverage enhancement mode, the first set of multiple shared channel resources spanning one or more slot boundaries and including at least a first shared channel resource and a second shared channel resource, the first shared channel resource separated from the second shared channel resource by a second set of multiple shared channel resources, means for communicating a first repetition of the shared channel message via the first shared channel resource of the first set of multiple shared channel resources in accordance with a first redundancy version, and means for communicating a second repetition of the shared channel message via the second shared channel resource of the first set of multiple shared channel resources in accordance with at least a partial rate matching of the first repetition to the second shared channel resource.

Another innovative aspect of the subject matter described in this disclosure can be implemented in a non-transitory computer-readable medium storing code for wireless communications is described. The code may include instructions executable by one or more processors to transmit DCI including a SLIV that schedules a first set of multiple shared channel resources for repetitions of a shared channel message in accordance with a coverage enhancement mode, the first set of multiple shared channel resources spanning one or more slot boundaries and including at least a first shared channel resource and a second shared channel resource, the first shared channel resource separated from the second shared channel resource by a second set of multiple shared channel resources, communicate a first repetition of the shared channel message via the first shared channel resource of the first set of multiple shared channel resources in accordance with a first redundancy version, and communicate a second repetition of the shared channel message via the second shared channel resource of the first set of multiple shared channel resources in accordance with at least a partial rate matching of the first repetition to the second shared channel resource.

Some examples of the method, network entities, and non-transitory computer-readable medium described herein may further include operations, features, means, or instructions for measuring a phase jump between the first repetition of the shared channel message in the first shared channel resource and the second repetition of the shared channel message in the second shared channel resource in accordance with a comparison of data tones or symbols, or both, of the first repetition and the second repetition.

### BRIEF DESCRIPTION OF THE DRAWINGS

FIG. 1 shows an example of a wireless communication system.

FIG. 2 shows an example of a signaling diagram that supports rate matching across repetitions for phase jump estimation across gaps.

FIG. 3 shows an example of a rate matching configuration that supports rate matching across repetitions for phase jump estimation across gaps.

FIG. 4 shows an example of an overlapped rate matching configuration that supports rate matching across repetitions for phase jump estimation across gaps.

FIG. 5 shows an example of a code block ordering that supports rate matching across repetitions for phase jump estimation across gaps.

FIG. 6 shows an example of a process flow that supports rate matching across repetitions for phase jump estimation across gaps.

FIG. 7 shows a block diagram of a processing system that supports rate matching across repetitions for phase jump estimation across gaps.

FIG. 8 shows a diagram of a system including a device that supports rate matching across repetitions for phase jump estimation across gaps.

FIG. 9 shows a block diagram of a processing system that supports rate matching across repetitions for phase jump estimation across gaps.

FIG. 10 shows a diagram of a system including a device that supports rate matching across repetitions for phase jump estimation across gaps.

FIGS. 11 through 14 show flowcharts illustrating methods that support rate matching across repetitions for phase jump estimation across gaps.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, a network entity may schedule a user equipment (UE) with shared channel resource allocations spanning a slot boundary to communicate repetitions of a shared channel message. For example, the UE may be scheduled to transmit multiple repetitions of an uplink shared channel message using uplink shared channel resources of different slots. The uplink shared channel resources may be separated by downlink shared channel resources, which may affect phase coherency across the repetitions of the uplink shared channel message. In some cases, the UE may maintain phase coherency by including demodulation reference signals (DMRSs) with the repetitions of the uplink shared channel message before and after time gaps of downlink shared channel resources, which may assist a receiver in measuring transmission phase discontinuity and decoding the repetitions. If the UE is operating according to a coverage enhancement mode, uplink shared channel resource allocations may be relatively smaller, for example including a limited quantity of resource blocks. Including DMRSs for such relatively small uplink shared channel resource allocations to maintain phase coherency across the repetitions, however, may significantly reduce throughput.

Aspects of the subject matter described in this disclosure relate to redundancy version repetition or rate matching across a phase jump boundary. For example, a network entity may schedule a UE to transmit multiple repetitions of an uplink shared channel message via multiple uplink shared channel resources. At least some of the uplink shared channel resources may be separated by downlink shared channel resources such that gaps between the uplink shared channel resources would break phase continuity between the repetitions. The UE may transmit a first repetition of the uplink shared channel message in a first uplink shared channel resource according to a first redundancy version, and the UE may transmit a second repetition of the uplink shared channel message in a second uplink shared channel resource according to the first redundancy version. For example, the UE may repeat a same redundancy version from the first repetition in the first uplink shared channel resource for the second repetition in the second uplink shared channel resource. In some examples, the network entity may indicate for the UE to use the same redundancy version for the two uplink shared channel resources. A device that receives the repetitions, such as the network entity, may measure a phase jump between the first uplink shared channel resource and the second uplink shared channel resource, for example by comparing tones of the first repetition and the second repetition of the uplink shared channel message.

In some examples, the UE may perform continuous rate matching across different repetitions, such that bits included in a beginning of the second shared channel resource are the same as bits at an end of the first shared channel resource. For example, the UE may rate match a portion of the first repetition communicated via the first shared channel resource to the beginning of the second shared channel resource used to communicate the second repetition, which may assist the network entity in estimating a phase jump between the first shared channel resource and the second shared channel resource. For example, the network entity may measure a phase jump between the first uplink shared channel resource and the second uplink shared channel resource by comparing the bits and/or symbols that are the same across the first repetition and the second repetition, as a first set of bits or symbols of the second repetition may be the same as a last set of bits or symbols of the first repetition. Although these techniques are generally described with reference to repetition for uplink shared channel signaling, these or similar techniques may also be implemented for downlink shared channel signaling. For example, a network entity transmit two downlink shared channel repetitions according to a same redundancy version across two downlink shared channel resources that are separated by a gap that disrupts phase continuity between the two downlink shared channel resources.

Particular aspects of the subject matter described in this disclosure can be implemented to realize one or more of the following potential advantages. In some examples, by repeating a same redundancy version for repetitions of a shared channel message in shared channel resources separated in time (for example, across a phase jump boundary), the described techniques can improve accuracy for phase jump estimation at a receiver. The improved accuracy for the phase jump estimation may enhance reliability and coverage for shared channel signaling. Additionally, or alternatively, by rate matching a portion of a first repetition communicated via a first shared channel resource to a second shared channel resource carrying a second repetition, the receiver may compare the common bits and/or symbols of the first and second shared channel resources to improve phase jump estimation accuracy, among various other advantages.

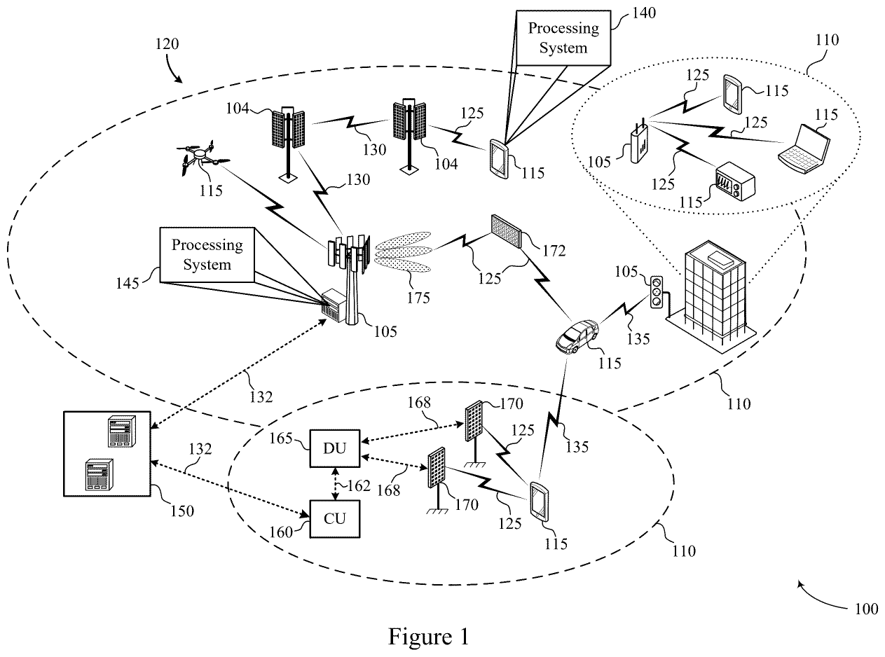

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating DCI and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, DMRSs that support demodulation, or phase tracking reference signals (PTRSs) for evaluating oscillator characteristics, among others. Network entities 105 and UEs 115 may receive and measure transmitted reference signals to support one or more of these and other functions.

The wireless communication system 100 may support techniques to improve coverage for shared channel signaling. For example, a network entity 105 may schedule a UE 115 for repeated PUSCH transmission with multiple segments of back-to-back symbols to extend PUSCH coverage. In some cases, the repetitions may take or use different redundancy versions of PUSCH. In some cases, each repetition segment may be within a slot boundary. For example, in some systems, the PUSCH resources used to communicate the repetitions may not cross a slot boundary.

The wireless communication system 100 may support DCI that includes a long start and length indicator value (SLIV) to schedule shared channel resources across a slot boundary. Shared channel resources scheduled by a long SLIV may have reduced DMRS overhead by applying a more uniform time domain DMRS pattern given (for example, in accordance with) doppler characteristics. In some cases, such as for TDD systems, PUSCH repetitions or fluid SLIV may be across multiple uplink resources that are separated by downlink resources. For example, the SLIV may allocate a first and a second PUSCH resource for repetitions of a PUSCH message, and the first and second PUSCH resources may be separated (for example, in time) by downlink resources (for example, PDSCH resources). The switching from uplink resources to downlink resources, pausing transmission at the UE 115, may result in phase discontinuity between the PUSCH repetitions.

In some cases, a transmitter operating according to a coverage enhancement mode that uses a long SLIV may use redundancy version repetition within resources scheduled by the long SLIV. Each transport block and/or code block may be rate matched within time segments including a nominal quantity of consecutive symbols. For example, the long SLIV may be segment into time segments with physical and/or logical boundaries, including at least a portion of a special slot and an uplink slot. The redundancy version index of each time segment may be preconfigured or determined by the transmitter and/or receiver according to a modulo operation. In some cases, some systems may support long SLIV repetition, where DCI schedules multiple long SLIVs, and each SLIV may use a different redundancy version.

If DMRS combining across the multiple PUSCH resources is feasible, a receiver (for example, a network entity 105 receiving the repetitions of the PUSCH message) may use DMRS combining to improve channel estimations for the PUSCH repetitions or fluid SLIV. In a medium Doppler scenario, at least one DMRS per uplink slot and a glue reference signal at the beginning or end of a gap may be included to improve phase jump estimation with minimal overhead. For example, a first uplink slot may include a glue reference signal near the end of the first uplink slot and at least one DMRS, and a second uplink slot that is separated in time from the first uplink slot (for example, such that a gap between the uplink slots results in a phase jump) may include a glue reference signal near the end of the second uplink slot and at least one DMRS. In a low doppler case (for example, with a stationary UE 115 such as a fixed surveillance camera), overhead for DMRS and/or glue reference signals may be reduced. For example, a middle uplink slot of three uplink slots in time may not have DMRS but may include a glue reference signal to improve a receiver in estimating a phase jump between the uplink slots.

For uplink signaling, low density glue reference signals may be allocated (for example, placed) before or after a downlink slot gap to support a receiver in measuring UE transmission phase or gain discontinuity. For example, the glue reference signals may enable the receiver to combine DMRSs across uplink slots. The glue reference signal density may be, for example, one tone per one, two, four, or eight resource blocks. In a high coverage extension mode, a PUSCH allocation may be just a few resource blocks, and a carrier-to-noise (CNR) ratio may be as low as −10 dB at a cell edge. In a low CNR region, a low density of glue reference signals may be insufficient to assist the receiver with performing phase jump measurement. For example, tens of glue reference signals may be sufficient to enable the receiver to perform an accurate phase jump estimation in low CNR regions. However, if very few resource blocks are allocated (for example, as low as one resource block for some coverage enhancement modes), and multiple tones (for example, 12 tones) of glue reference signals are in each time segment or PUSCH allocation of a long SLIV, overhead for the glue reference signals may significantly reduce throughput.

The wireless communication system 100 may support low overhead techniques that support phase jump estimation across a gap while a coverage extension mode is enabled. For example, in a coverage enhancement mode, for two time segments (for example, shared channel resources) across downlink/uplink switching where phase coherency cannot be maintained, a transmitter may repeat a same redundancy version from a first symbol of each of the two time segments. For example, the transmitter may rate match a same redundancy version to two time segments (for example, shared channel resources) if phase coherency cannot be maintained between the two time segments, for example in association with a transmission gap between the two time segments. In some examples, the transmitter may perform continuous rate matching for two repetition time segments with partial symbol overall (for example X-symbol overlap). The transmitter may, for example, remove system bit priority mapping (SBPM) information interleaving, such that a last X symbols of a first time segment (for example, shared channel resource) and a first X symbols of a second time segment are the same.

Devices of the wireless communication system 100 may be configured to support one or more aspects of the described techniques for rate matching across repetitions for phase jump estimation across gaps. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support accurate phase jump estimation across a slot gap between two shared channel resources used to communicate repetitions of a shared channel message.

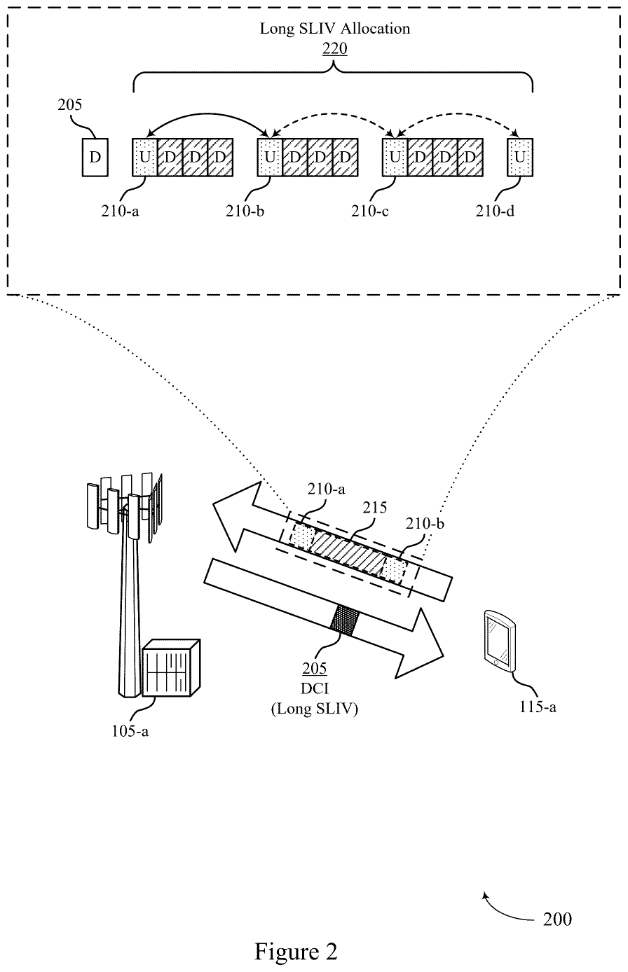

FIG. 2 shows an example of a signaling diagram 200 that supports rate matching across repetitions for phase jump estimation across gaps. The signaling diagram 200 may implement aspects of a wireless communication system 100 described with reference to FIG. 1. For example, the signaling diagram 200 may include a UE 115-a and a network entity 105-a, which may be respective examples of a UE 115 and a network entity 105 described herein.

The UE 115-a or the network entity 105-a, or both, may operate according to a coverage enhancement mode or a coverage extension mode. For example, the UE 115-a may operate in a region with low CNR (for example, at a cell edge of the network entity 105-a), and the network entity 105-a may configure the UE 115-a for a high coverage enhancement mode. In some examples, the network entity 105-a may transmit control signaling that configures the UE 115-a to operate according to the coverage enhancement mode. For example, RRC signaling, DCI, or a MAC control element may configure the UE 115-a to operate according to the coverage enhancement mode.

In some examples, the network entity 105-a may configure or schedule the UE 115-a for shared channel repetition, for example as part of the coverage enhancement mode. The UE 115-a may support communication of DCI carrying a long SLIV, such as a DCI 205. The DCI 205 may schedule the UE 115-a to communicate (for example, transmit or receive) multiple repetitions of a shared channel message via shared channel resources that cross one or more slot boundaries. In the example of FIG. 2, the network entity 105-a may transmit the DCI 205 that includes a long SLIV to schedule the UE 115-a to transmit multiple PUSCH repetitions. In other examples, the network entity 105-a may schedule the UE 115-a to receive multiple PDSCH repetitions via a long SLIV.

A long SLIV allocation 220 may include multiple PUSCH resources that cross one or more slot boundaries. For example, the long SLIV allocation 220 may schedule a PUSCH resource 210-a, a PUSCH resource 210-b, a PUSCH resource 210-c, and a PUSCH resource 210-d. In some examples, each PUSCH resource 210 may be in a different slot, and the PUSCH resources 210 may be separated by downlink slots 215. For example, the PUSCH resource 210-a and the PUSCH resource 210-b may be separate by one or more downlink slots, such that there is a gap between the UE 115-a transmitting a first PUSCH repetition via the PUSCH resource 210-a and a second PUSCH repetition via the PUSCH resource 210-b.

Phase continuity may be broken or not maintained between two shared channel resources that are separated by a gap in time. For example, phase continuity may not be maintained between the UE 115-a transmitting the first PUSCH repetition via the PUSCH resource 210-a and the UE 115-a transmitting the second PUSCH repetition via the PUSCH resource 210-b. In some examples, phase continuity and/or power consistency may be broken based on, for example, a change in a resource block allocation, a change in power or use of different power control parameters, a change to a timing advance, or a beam change. Scheduling the UE 115-a with the DCI 205 that allocates the long SLIV allocation 220 may prevent phase continuity breaks from these factors, as the UE 115-a may be configured to use consistent parameters (for example, RB allocation, power parameters, timing advance, beamforming configuration) for the long SLIV allocation 220.

Other factors or events may also break phase continuity and/or power consistency. For example, intervening downlink measurement, monitoring, or reception, or any combination thereof, may break phase continuity. The network entity 105-a may prevent phase continuity breaks from downlink signaling by refraining from scheduling the UE 115-a for downlink signaling between two PUSCH resources. In some examples, a gap between transmission (for example, transmission via a first PUSCH resource of the long SLIV allocation 220 and a second PUSCH resource of the long SLIV allocation 220) that is longer than a threshold (for example, greater than 13 symbols) may break phase continuity. Additionally, or alternatively, radiofrequency reconfiguration at the transmitter (for example, the UE 115-a) may break phase continuity.

The UE 115-a or the network entity 105-a, or both, may support techniques to improve phase jump estimation at a receiver. For example, a transmitter may implement redundancy version repetition across a phase jump boundary or overlapped continuous rate matching for different repetitions, or both. These techniques may have low overhead compared to, for example, including a large quantity of glue reference signals as described with reference to FIG. 1, as the large quantity of glue reference signals may significantly reduce throughput in high coverage enhancement modes.

For example, the UE 115-a may transmit PUSCH repetitions via a first time segment (for example, the PUSCH resource 210-a) and a second time segment (for example, the PUSCH resource 210-b), where a TDD pattern switches to downlink resources between the first time segment and the second time segment such that phase coherency cannot be maintained. The UE 115-a may repeat a same redundancy version from a first symbol of each of the two time segments. For example, the UE 115-a may rate match a same redundancy version to two time segments where phase coherence cannot be maintained. For example, a first repetition transmitted via the PUSCH resource 210-a may be in accordance with a first redundancy version, and a second repetition transmitted via the PUSCH resource 210-b may be in accordance with the first redundancy version. Similarly, a third repetition transmitted via the PUSCH resource 210-c may be in accordance with a second redundancy version, and a fourth repetition transmitted via the PUSCH resource 210-d may be in accordance with the second redundancy version. For example, the PUSCH resource 210-c and the PUSCH resource 210-d may be another example of a pair of time segments with a gap that break phase continuity.

Between the two time segments, for example between the PUSCH resource 210-a and the PUSCH resource 210-b, the network entity 105-a may not schedule PDSCH (for example, for the UE 115-a) and does not expect the UE 115-a to monitor PDCCH or perform downlink measurements. For example, the UE 115-a may not monitor for PDCCH, receive PDSCH signaling, or perform downlink measurements during the downlink slots 215 between the PUSCH resource 210-a and the PUSCH resource 210-b.

The DCI 205 that schedules the long SLIV allocation 220 may indicate a same redundancy version index for the PUSCH resource 210-a and the PUSCH resource 210-b. For example, the long SLIV scheduling DCI (for example, the DCI 205) may indicate a same redundancy version for two time segments across downlink switching where phase coherency cannot be maintained. In some examples, the UE 115-a may suspend downlink monitoring, measurement, and reception based on the DCI 205. For example, if two time segments of contiguous uplink symbols in a long SLIV or across two SLIV repetitions are scheduled with different redundancy versions by a long SLIV DCI or a multi-long SLIV DCI, the UE 115-a may skip monitoring for DCI, performing downlink measurements, or receiving downlink signaling in downlink resources (for example, one or more downlink slots) between the two time segments. The UE 115-a may suspend search space monitoring in the gap to avoid switching from operating for uplink signaling to operating for downlink signaling. If there is DCI-scheduled PDSCH in the gap (for example, the downlink slots 215), the UE 115-a may not receive the PDSCH (for example, treating the DCI-scheduled PDSCH as an error case). The UE 115-a may not perform, for example, CSI-RS measurement, RSRP measurement, or RSSI measurement during the gap.

The network entity 105-a may receive the PUSCH repetitions via the PUSCH resource 210-a and the PUSCH resource 210-b and measure a phase jump across the gap (the downlink slots 215). The network entity 105-a may compare the same two tones in the same two data symbols from the two time segments (for example, the PUSCH resource 210-a and the PUSCH resource 210-b) across the gap. For example, the same redundancy version may be used for the repetition transmitted via the PUSCH resource 210-a and the PUSCH resource 210-b, such that the same tones and data symbols (for example, data symbol indexes) in the PUSCH resource 210-a and the PUSCH resource 210-b carry the same information or signaling. The network entity 105-a may determine how much phase continuity and/or power consistency has changed between the PUSCH resource 210-a and the PUSCH resource 210-b by comparing these tones and data symbols of the two PUSCH resources.

The network entity 105-a may additionally, or alternatively, measure the phase jump based on DMRSs of the PUSCH resources. If two time segments have different DMRS time patterns, the DMRS symbols may be time division multiplexed with the shared channel resources. The same symbol being in two time segments may be defined as the same shared channel symbol index (for example, shared channel only or not including symbols with a DMRS) relative to each time segment. If CSI-RS is configured, a shared channel resource may be punctured instead of remapping, and phase jump estimation may skip the tones where CSI-RS punctures the shared channel resource. For example, if CSI-RS punctures tones in a third symbol of the PUSCH resource 210-a and the PUSCH resource 210-b, the network entity 105-a may compare all of a first symbol, a second symbol, and a fourth symbol of the PUSCH resource 210-a and the PUSCH resource 210-b, and the network entity 105-a may compare tones which are not punctured by CSI-RS of the third symbol of the PUSCH resource 210-a and the PUSCH resource 210-b. In some examples, phase estimation may be averaged across data tones or data symbols, or both.

In some examples, the UE 115-a may send capability information corresponding to phase continuity. For example, even without downlink monitoring, reception, or measurement, different UEs or UE implementations may be able to maintain phase continuity of uplink transmissions for different durations of symbol time. The UE 115-a may transmit a capability report indicating a threshold quantity of symbols of suspended uplink transmission the UE 115-a can be scheduled for while maintaining phase coherency after resuming transmission. The UE capability may affect how the network entity 105-a performs cross-repetition DMRS bundling when estimating phase jumps. For example, if the UE 115-a can support a larger quantity of gap symbols while maintaining phase continuity, the network entity 105-a may schedule the UE 115-a such that DMRS bundling may maintain phase continuity across the gaps. For example, the network entity 105-a may schedule two repetitions with the same redundancy version allowing phase jump estimation and DMRS bundling across repetitions when the gap between two time segments exceeds the quantity of symbols in the downlink gap indicated by the UE capability. If the gap is smaller than the quantity of symbols corresponding to the UE capability, the network entity 105-a may, in some cases, schedule the repetitions with different redundancy versions and use DMRS bundling to perform phase jump estimation.

In some cases, using a same redundancy version across two time segments may reduce coding diversity compared to using different redundancy versions. The signaling diagram 200 may support techniques for continuous rate matching for two repetition time segments with X symbols overlapping between the time segments. In some examples, the continuous rate matching techniques may include removing SBPM interleaving. For example, the SBPM interleaving may place system bits starting from a most-significant bit (MSB) of a QAM-modulated symbol to improve robustness. In a coverage enhancement mode, for QPSK, disabling SBPM may not affect robustness, as in-phase and quadrature components of the QPSK-modulated symbol may be equally protected. Disabling SBPM interleaving may enable the first X symbols of a second time segment to be the same as the last X symbols of a first time segment using overlapped continuous rate matching.

In some examples, the quantity of symbols (for example, the X symbols) may impact a quantity of data tones across the two time segments which may be used for phase jump estimation. The quantity of overlapping symbols (X) for continuous redundancy version rate matching may be preconfigured via RRC signaling or indicated by DCI (for example, the DCI 205). In some examples, the quantity of symbols may be based on coverage enhancement mode or receiver SNR, or both.

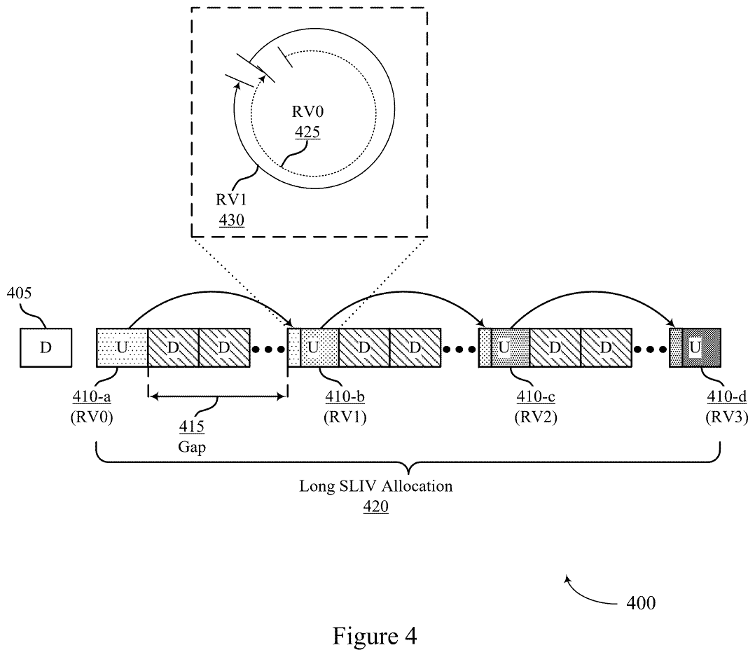

For example, for two time segments (for example, shared channel resources) in a coverage enhancement mode, a transmitter may disable SBPM interleaving and performing overlapped continuous rate matching for two different redundancy versions in the two time segments. The two time segments may be repetition time segments (for example shared channel resources allocated for PUSCH repetition or PDSCH repetition) or two long SLIV repetitions. The transmitter may perform overlapped continuous rate matching for two repetition time segments where a starting point of an RV associated with the second segment is Y bits, corresponding to a configured or indicated X OFDM symbols, before an end of the redundancy version associated with the first time segment. This may enable the last X data symbols of the first time segment to be the same as the first X data symbols of the second time segment. The Y bits may be a function of resource block allocation, modulation (for example, modulation and coding scheme), or quantity of spatial layers, or any combination thereof. Overlapped continuous rate matching for different repetitions is described in more detail with reference to FIG. 4.

As an example, the UE 115-a may transmit a first PUSCH repetition via the PUSCH resource 210-a according to a first redundancy version. The UE 115-a may rate match a portion of the first PUSCH repetition to the PUSCH resource 210-b. For example, the start of the PUSCH resource 210-b may carry X symbols of the first PUSCH repetition according to the first redundancy version. After the X symbols, the PUSCH resource 210-b may carry a second PUSCH repetition according to a second redundancy version. Similarly, a last X symbols of the second PUSCH repetition may be carried via the PUSCH resource 210-c, and a remainder of the PUSCH resource 210-c may be used to communicate a third PUSCH repetition in accordance with a third redundancy version.

In some examples, each time segment (for example, shared channel resource) may include multiple code blocks. The signaling diagram may support techniques for ordering code block to enable overlapped continuous rate matching with multiple code blocks. For example, a transmitter (encoder) may reverse an order of code blocks in a second time segment with respect to a first time segment, such that code blocks of a same index are received closer in time to each other. For example, this may enable the last X symbols of the first time segment and the first X symbols of the following time segment to be the same, as these symbols may be from the same code block.

The network entity 105-a may receive the first repetition in accordance with the first redundancy version via the PUSCH resource 210-a. The network entity 105-a may receive the second repetition via the PUSCH resource 210-b, where a portion of the first repetition is rate matched to the PUSCH resource 210-b. The network entity 105-a may estimate a phase jump between the PUSCH resource 210-a and the PUSCH resource 210-b by comparing the last X symbols of the PUSCH resource 210-a to the first X symbols of the PUSCH resource 210-b.

While these techniques are generally described with reference to PUSCH repetition, they may also be applied for PDSCH repetition. For example, DCI may schedule the UE 115-a to receive PDSCH repetitions according to a long SLIV allocation. The network entity 105-a may, for example, use a same redundancy version for a PDSCH repetition transmitted via a first PDSCH resource and a second PDSCH resource, if the first PDSCH resource and the second PDSCH resource are separated such that there is phase discontinuity between the first PDSCH resource and the second PDSCH resource. The UE 115-a may perform phase jump estimation based on the same data tones or same data symbols of the first PDSCH resource and the second PDSCH resource.

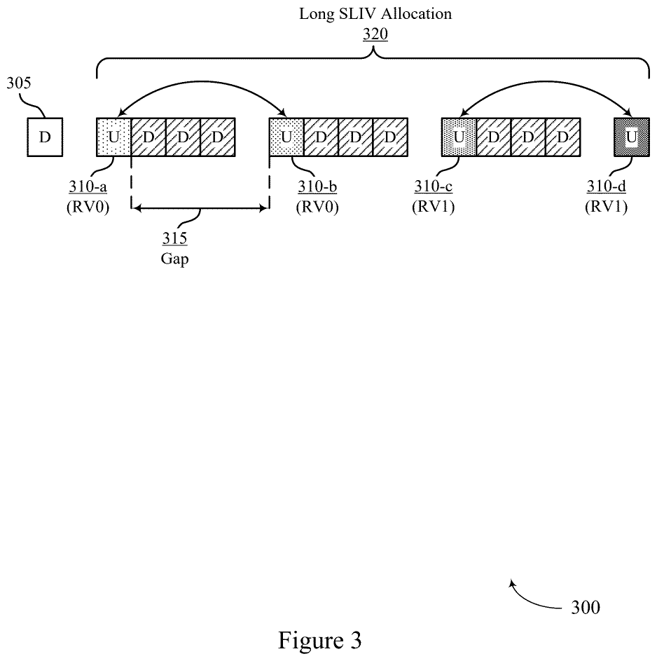

FIG. 3 shows an example of a rate matching configuration 300 that supports rate matching across repetitions for phase jump estimation across gaps. The rate matching configuration 300 may implement aspects of a wireless communication system 100 or a signaling diagram 200, or both.

A UE 115 may be configured to operate according to a coverage enhancement mode. A network entity 105 may schedule the UE 115 for PUSCH repetition via DCI that includes a long SLIV. The network entity 105 may transmit the DCI via a downlink slot 305. The DCI may indicate a long SLIV allocation 320, including a set of PUSCH resources 310 for the PUSCH repetitions. The PUSCH resources 310 may be separated by gaps (for example, a gap 315), such that phase continuity is not maintained between the PUSCH resources. For example, a gap in time between a PUSCH resource 310-a (for a first PUSCH repetition) and a PUSCH resource 310-b (for a second PUSCH repetition) may be greater than a threshold, such that the UE 115 cannot maintain phase continuity between transmitting the first PUSCH repetition and the second PUSCH repetition.

The rate matching configuration 300 shows an example of redundancy version repetition across a phase jump boundary. For example, the UE 115 transmit a first PUSCH repetition via the PUSCH resource 310-a according to a first redundancy version (“RV0” in FIG. 3). The UE 115 may transmit a second PUSCH repetition via the PUSCH resource 310-b according to the same redundancy version (for example, the first redundancy version) as the PUSCH resource 310-a. For example, the same redundancy version may be rate matched to two time segments (the PUSCH resource 310-a and the PUSCH resource 310-b) when phase coherency cannot be maintained between the time segments. The same data tones and data symbols may be used for the PUSCH resource 310-a and the PUSCH resource 310-b to transmit the PUSCH repetitions. Similarly, the UE 115 may rate match a same redundancy version (“RV1” in FIG. 3) to a PUSCH resource 310-c and a PUSCH resource 310-d.

A receiver, such as the network entity 105, may measure a phase jump between the PUSCH resource 310-a and the PUSCH resource 310-b. For example, the receiver may measure the phase jump based on the same redundancy version being repeated for the first PUSCH repetition and the second PUSCH repetition. The receiver may compare the same two tones in the same two data symbols from two time segments across the gap. For example, the receiver may compare a first tone in a first data symbol of the PUSCH resource 310-a to a first tone in a first data symbol of the PUSCH resource 310-b, as the first tone in the first data symbol should be the same for both PUSCH resources. The receiver may determine how much the phase has shifted based on the comparison. In some examples, the receiver may perform multiple phase jump estimations (for example, comparing multiple tones in one or more symbols). The phase jump estimation may be based on an average of phase differences across multiple data tones or symbols.

FIG. 4 shows an example of an overlapped rate matching configuration 400 that supports rate matching across repetitions for phase jump estimation across gaps. The overlapped rate matching configuration 400 may implement aspects of a wireless communication system 100 or a signaling diagram 200, a rate matching configuration 300, or any combination thereof.

A UE 115 may be configured to operate according to a coverage enhancement mode. A network entity 105 may schedule the UE 115 for PUSCH repetition via DCI that includes a long SLIV. The network entity 105 may transmit the DCI via a downlink slot 405. The DCI may indicate a long SLIV allocation 420, including a set of PUSCH resources 410 for the PUSCH repetitions. The PUSCH resources 410 may be separated by gaps (for example, a gap 415), such that phase continuity is not maintained between the PUSCH resources 410. For example, a gap in time between a PUSCH resource 410-a (for a first PUSCH repetition) and a PUSCH resource 410-b (for a second PUSCH repetition) may be greater than a threshold, such that the UE 115 cannot maintain phase continuity between transmitting the first PUSCH repetition and the second PUSCH repetition.

The overlapped rate matching configuration 400 shows an example of overlapped continuous rate matching for two different redundancy versions in two time segments. The two time segments may be repetition time segments in a long SLIV (for example, the PUSCH resources 410 within the long SLIV allocation 420) or two long SLIV repetitions. The UE 115 may perform overlapped continuous rate matching for two repetition time segments, where a starting point of the redundancy version associated with the second segment is Y bits (corresponding to X OFDM symbols) before an ending of the redundancy version associated with the first segment.

For example, the UE 115 may transmit a first PUSCH repetition via PUSCH resource 410-a. The first PUSCH repetition may be in accordance with a first redundancy version 425 (“RV0” in FIG. 4). The UE 115 may transmit a second PUSCH repetition via a PUSCH resource 410-b. A portion of the first PUSCH repetition may be rate matched to the PUSCH resource 410-b. For example, a last X symbols of the first PUSCH repetition may be rate matched to the first X symbols of the PUSCH resource 410-b. A remainder of the second PUSCH repetition may be in accordance with a second redundancy version 430 (“RV1” in FIG. 4). For example, the last X symbols of the first PUSCH repetition (communicated via the PUSCH resource 410-a) may be the same as the first X symbols of the second PUSCH repetition (communicated via the PUSCH resource 410-b). Similarly, a first X symbols of a PUSCH repetition transmitted via PUSCH resource 410-c may be the same as a last X symbols of the PUSCH repetition transmitted via the PUSCH resource 410-b, and a first X symbols of a PUSCH repetition transmitted via PUSCH resource 410-d may be the same as a last X symbols of the PUSCH repetition transmitted via the PUSCH resource 410-c.

A quantity for the X symbols may be configured by the network entity 105. For example, the quantity of X overlapping symbols for continuous redundancy version rate matching may be configurable. In some examples, the quantity may be semi-statically configured via RRC signaling. Additionally, or alternatively, the quantity may be dynamically indicated or updated via DCI.

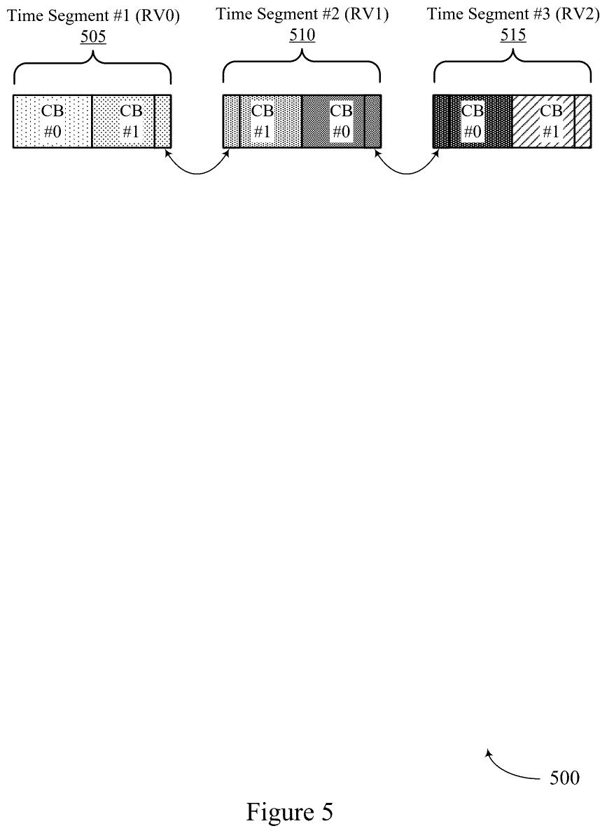

FIG. 5 shows an example of a code block ordering 500 that supports rate matching across repetitions for phase jump estimation across gaps. The code block ordering 500 may implement aspects of a wireless communication system 100 or a signaling diagram 200, a rate matching configuration 300, or an overlapped rate matching configuration 400 or any combination thereof.

As described with reference to FIG. 4, a transmitter may perform overlapped continuous rate matching over shared channel resources that cross a phase jump boundary to assist a receiver in performing a phase jump estimation for shared channel repetition. In some examples, each time segment (for example, shared channel resource) may include multiple code blocks. For example, each time segment may include a first code block (“CB #0” in FIG. 5) and a second code block (“CB #1” in FIG. 5). For example, each of a first time segment 505, a second time segment 510, and a third time segment 515 may include the first code block and the second code block. The first code block and the second code block in each time segment may be the same (for example, as the time segments carry repetitions of shared channel signaling).

The first time segment 505 may be in accordance with a first redundancy version (“RV0” in FIG. 5). For example, a transmitted may transmit a first shared channel repetition (for example, a first PUSCH repetition or a first PDSCH repetition) in accordance with the first redundancy version during the first time segment 505. The second time segment 510 may be in accordance with a second redundancy version (“RV1” in FIG. 5). A first X symbols of the last time segment may be the same as a last X symbols of the first time segment, facilitated by the code block ordering 500. For example, the transmitter may adjust an ordering of code blocks in a time segment such that code block order is iteratively reversed across two time segments. For example, the first code block (CB #0) may be transmitted first and the second code block (CB #1) may be transmitted second in the first time segment 505 and the third time segment 515, and the second code block (CB #1) may be transmitted first and the first code block (CB #0) may be transmitted second in the second time segment 510. By reversing the code block ordering for the second time segment 510, the last X symbols of the first time segment 505 and the first X symbols of the second time segment 510 may correspond to a same code block, such that these symbols can be the same.

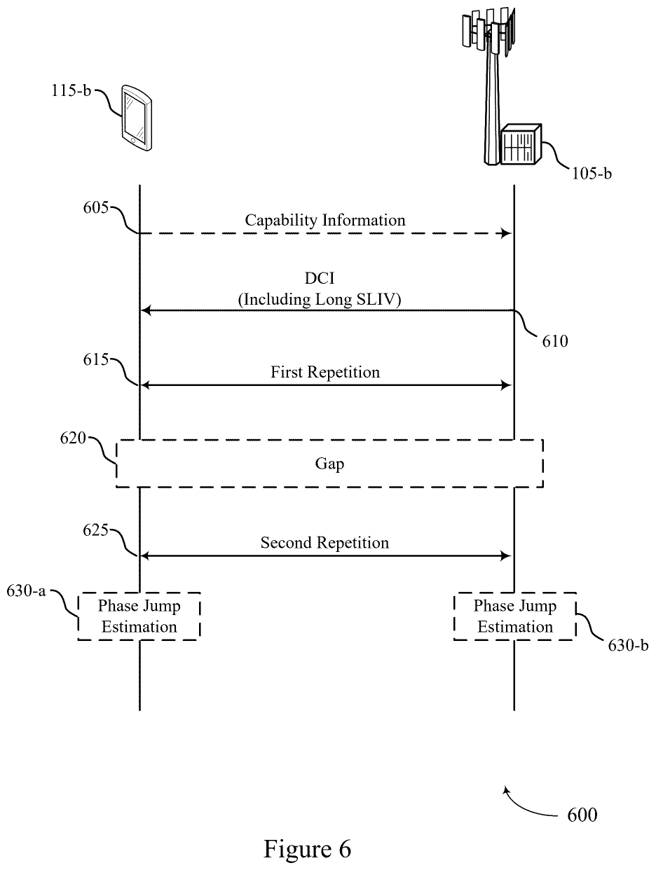

FIG. 6 shows an example of a process flow 600 that supports rate matching across repetitions for phase jump estimation across gaps. The process flow 600 may implement aspects of a wireless communication system 100, a signaling diagram 200, a rate matching configuration 300, an overlapped rate matching configuration 400, or a code block ordering 500, or any combination thereof. For example, the process flow 600 may be implemented by a UE 115-b or a network entity 105-b, or both, which may be respective examples of a UE 115 and a network entity 105 described herein.

Alternative examples of the following may be implemented, where some steps are performed in a different order than described or are not performed at all. In some cases, steps may include additional features not mentioned below, or further steps may be added. Although the UE 115-b and the network entity 105-b are shown performing the operations of the process flow 600, some aspects of some operations may also be performed by one or more other wireless devices.

The network entity 105-b may transmit DCI to the UE 115-b at 610. For example, the UE 115-b may receive DCI including a SLIV that schedules a first set of shared channel resources for repetitions of a shared channel message in accordance with a coverage enhancement mode. The SLIV may be an example of a long SLIV that schedules a shared channel resource allocation across one or more slot boundary. For example, the first set of shared channel resources may span one or more slot boundaries. The first set of shared channel resources may include at least a first shared channel resource and a second shared channel resource that are separated (for example, in time) by a second set of shared channel resources. For example, there may be a gap between each shared channel resource of the first set of shared channel resources.

The gap between, for example, the first shared channel resource and the second shared channel resource may cause phase discontinuity and/or power discontinuity at a transmitter between the first shared channel resource and the second shared channel resource. For example, each shared channel resource of the first set of shared channel resources may include a small quantity of resource blocks according to the coverage enhancement mode. While a transmitter may include glue reference signals for allocations with a larger quantity of resource blocks to assist a receiver in estimating a phase jump across a gap of two shared channel resources, using glue reference signals for small shared channel resource allocations (such as those in the first set of shared channel resources) may result in significant overhead which reduces throughput. The UE 115-b or the network entity 105-b, or both, may support techniques to assist a receiver in estimating a phase jump between (for example, time-separated) repetitions of a shared channel message.

In some examples, the shared channel resources may be PUSCH resources. For example, the DCI may schedule the UE 115-b to transmit repetitions of a PUSCH message via a first set of PUSCH resources. The gaps between the PUSCH resources may be downlink resources, such as PDSCH resources. In some other examples, the shared channel resources may be PDSCH resources. For example, the DCI may schedule the UE 115-b to receive repetitions of a PDSCH message via a first set of PDSCH resources. The gaps between the PDSCH resources may be uplink resources, such as PUSCH resources.

In some examples, at 605, the UE 115-b may transmit capability information to the network entity 105-b. For example, the UE 115-b may transmit capability information of the UE 115-b that indicates a threshold quantity of symbols of suspended uplink transmission between two uplink shared channel resources that have phase coherency. The capability information may indicate a maximum quantity of symbols of suspended uplink transmission the UE 115-b can experience while maintaining phase coherency after resuming uplink transmission. In some examples, the SLIV of the DCI received at 610 may schedule the UE 115-b for the shared channel resources based on the capability information of the UE 115-b. In some examples, the UE 115-b may transmit the capability information via RRC signaling or during an initial access procedure with the network entity 105-b, or both.

At 615, the UE 115-b or the network entity 105-b, or both, may communicate a first repetition of the shared channel message via the first shared channel resource of the first set of shared channel resources in accordance with a first redundancy version. In some examples, the first set of shared channel resources may be PUSCH resources, and the UE 115-b may transmit, and the network entity 105-b may receive, the first repetition of a PUSCH message via a first PUSCH resource. In some examples, the first set of shared channel resources may be PDSCH resources, and the network entity 105-b may transmit, and the UE 115-b may receive, the first repetition of a PDSCH message via a first PDSCH resource.

There may be a gap 620 in time between the first resource and the second resource. For example, if the first set of resources are PUSCH resources, the gap may include downlink resources. The UE 115-b may skip monitoring for DCI, performing downlink measurements, or receiving downlink signaling during the gap 620 between PUSCH resources. For example, skipping downlink monitoring, reception, and measurement during the gap may reduce phase discontinuity at the UE 115-b between the first PUSCH resource and the second PUSCH resource. If the first set of resources are PDSCH resources, the gap 620 may include uplink resources, such as PUSCH resources.

At 625, the UE 115-b or the network entity 105-b, or both, may communicate a second repetition of the shared channel message. For example, the UE 115-b or the network entity 105-b, or both, may communicate the second repetition via the second shared channel resource of the first set of shared channel resources in accordance with at least a partial rate matching of the first repetition to the second shared channel resource.

In some examples, the UE 115-b or the network entity 105-b, or both, may implement redundancy version repetition across a phase jump boundary. For example, the first repetition and the second repetition may be in accordance with a same redundancy version. A transmitter device (the UE 115-b if the shared channel resources are PUSCH resources or the network entity 105-b if the shared channel resources are PDSCH resources) may rate match a same redundancy version to two time segments, such as the shared channel resources, where the phase coherency cannot be maintained. For example, the first repetition of the shared channel message may be rate matched to the second shared channel resource of the first set of shared channel resources, and the second repetition of the shared channel message may be in accordance with the first redundancy version. In some examples, the DCI may indicate that the first shared channel resource and the second shared channel resource correspond to a same redundancy version (for example, the first redundancy version).

In some examples, the UE 115-b or the network entity 105-b, or both, may implement overlapped continuous rate matching for different repetitions. A transmitter (for example, the UE 115-b or the network entity 105-b) may rate match a last portion of the first repetition of the shared channel message to a beginning portion of the second shared channel resource. For example, a last X symbols of the first repetition may be rate matched to a first X symbols of the second shared channel resource, such that the last X data symbols of the first time segment (for example, the first shared channel resource) and the first X data symbols of the second time segment (for example, the second shared channel resource) are the same. The portion of the first repetition that is rate matched to the beginning portion of the second shared channel resource may correspond to a first quantity of bits of the first repetition, the first quantity of bits being in accordance with a resource block allocation, an MCS, or a quantity of spatial layers, or any combination thereof, used to communicate the first repetition and the second repetition. In some examples, the UE 115-b or the network entity 105-b, or both, may implement code block ordering as described with reference to FIG. 6 for overlapped continuous rate matching for different repetitions.

At 630, the UE 115-b or the network entity 105-b may estimate a phase jump between the first repetition and the second repetition. For example, a receiver may measure a symbol-to-symbol phase jump between the first repetition and the second repetition. The receiver may measure a phase jump across the gap 620 by comparing a same two tones in the same two data symbols from two time-segments across the gap. For example, the receiver may compare an Nth tone in an Mth data symbol of the first repetition to an Nth tone in an Mth data symbol of the second repetition. The receiver may perform multiple comparisons and measure the phase jump based on the multiple comparisons. In some examples, the phase jump measurement may be based on an average across multiple data tones or symbols. The UE 115-b may perform the phase jump estimation at 630-a if the first set of shared channel resources are PDSCH resources and the shared channel message is a PDSCH message. The network entity 105-b may perform the phase jump estimation at 630-b if the first set of shared channel resources are PUSCH resources and the shared channel message is a PUSCH message. In some examples, CSI-RS may be configured, and the first set of shared channel resources may be punctured by CSI-RS. The receiver may skip tones carrying CSI-RS when performing the phase jump estimation. For the receiver may perform a phase jump measurement between the first repetition and the second repetition that skips one or more tones in accordance with the one or more tones being punctured by one or more CSI-RS in the first repetition or the second repetition.

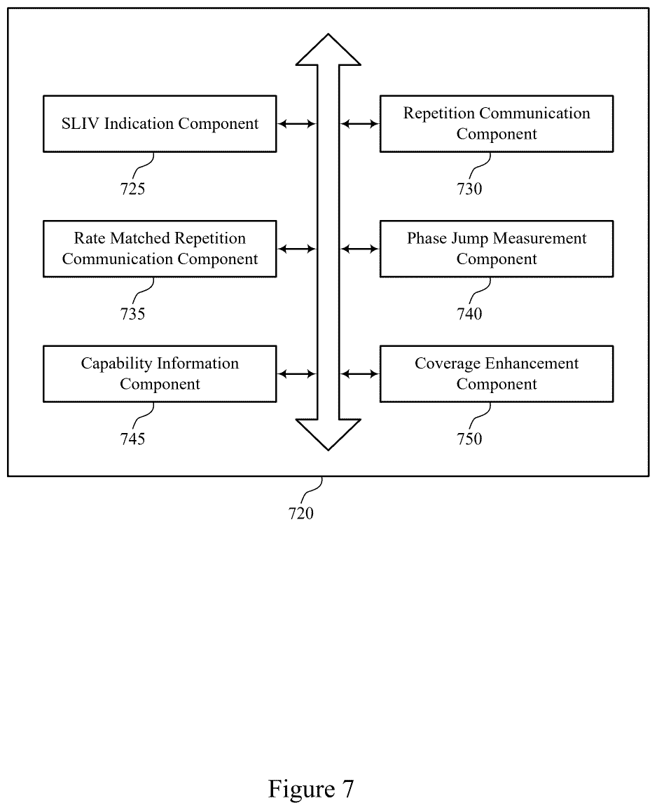

FIG. 7 shows an example of a processing system 720 that supports rate matching across repetitions for phase jump estimation across gaps. A processing system 720 may be an example of a processing system 140 (such as of a UE 115) and may include an SLIV indication component 725, a repetition communication component 730, a rate matched repetition communication component 735, a phase jump measurement component 740, a capability information component 745, a coverage enhancement component 750, or any combination thereof. A processing system 720, or various component thereof, may be an example of means for performing (such as a means for causing a UE 115 to perform) various techniques described herein.

The SLIV indication component 725 may be configured to cause the UE 115 to receive DCI including a SLIV that schedules a first set of multiple shared channel resources for repetitions of a shared channel message in accordance with a coverage enhancement mode, the first set of multiple shared channel resources spanning one or more slot boundaries and including at least a first shared channel resource and a second shared channel resource, the first shared channel resource separated from the second shared channel resource by a second set of multiple shared channel resources. The repetition communication component 730 may be configured to cause the UE 115 to communicate a first repetition of the shared channel message via the first shared channel resource of the first set of multiple shared channel resources in accordance with a first redundancy version. The rate matched repetition communication component 735 may be configured to cause the UE 115 to communicate a second repetition of the shared channel message via the second shared channel resource of the first set of multiple shared channel resources in accordance with at least a partial rate matching of the first repetition to the second shared channel resource.

In some examples, the first repetition of the shared channel message is rate matched to the second shared channel resource of the first set of multiple shared channel resources, and the second repetition of the shared channel message is in accordance with the first redundancy version.

In some examples, the DCI indicates that the first shared channel resource and the second shared channel resource correspond to the first redundancy version.

In some examples, the phase jump measurement component 740 may be configured to cause the UE 115 to perform a phase jump measurement between the first repetition and the second repetition that skips one or more tones in accordance with the one or more tones being punctured by one or more channel state information reference signals in the first repetition or the second repetition.

In some examples, the SLIV indication component 725 may be configured to cause the UE 115 to skip a monitoring for DCI, a reception of a downlink signal, or a measurement of a downlink signal, or any combination thereof, between the first shared channel resource of the first set of multiple shared channel resources and the second shared channel resource of the first set of multiple shared channel resources.

In some examples, the capability information component 745 may be configured to cause the UE 115 to transmit capability information of the UE that indicates a threshold quantity of symbols of suspended uplink transmission between two uplink shared channel resources corresponding to the first set of multiple shared channel resources that have phase coherency, where the SLIV is in accordance with the capability information of the UE.

In some examples, a portion of the first repetition of the shared channel message is rate matched to a beginning portion of the second shared channel resource that corresponds to bit indexes for system bit priority mapping information, and the second repetition of the shared channel message is in accordance with a second redundancy version that is different than the first redundancy version.

In some examples, the portion of the first repetition that is rate matched to the beginning portion of the second shared channel resource corresponds to a first quantity of bits of the first repetition, the first quantity of bits being in accordance with a resource block allocation, a modulation and coding scheme, or a quantity of spatial layers, or any combination thereof, used to communicate the first repetition and the second repetition.

In some examples, the rate matched repetition communication component 735 may be configured to cause the UE 115 to receive control signaling that indicates a quantity of symbols in the portion of the first redundancy version that is rate matched to the beginning portion of the second repetition of the shared channel message.

In some examples, a second code block order of code blocks of the second repetition is reversed from a first code block order of code blocks of the first repetition in accordance with the portion of the first repetition being rate matched to the beginning portion of the second shared channel resource.

In some examples, the rate matched repetition communication component 735 may be configured to cause the UE 115 to decode the second repetition of the shared channel message in accordance with at least the partial rate matching of the first repetition to the second shared channel resource, the first set of multiple shared channel resources being downlink shared channel resources.

In some examples, the rate matched repetition communication component 735 may be configured to cause the UE 115 to rate matching at least a portion of the first repetition to the second share channel resource, the first set of multiple shared channel resources being uplink shared channel resources.

In some examples, the coverage enhancement component 750 may be configured to cause the UE 115 to receive a control signal that configures the UE for a coverage enhancement mode, the SLIV scheduling the first set of multiple shared channel resources in accordance with the coverage enhancement mode.

A processing system 720 may include or be a component of one or more chips, systems-on-chips (SoCs), chipsets, packages, components, or devices that individually or collectively constitute or include a processing system. A processing system 720 may interface with other components of a processing system 720. For example, operations described with reference to a processing system 720, or various components thereof, may be performed by or with other such components, including a receiver, a transmitter, a transceiver, a modem, a user interface, a modulator/demodulator, an encoder/decoder, or any combination thereof (such as of the processing system 720, coupled with the processing system 720, of a processing system 720).

By including or configuring a processing system 720 for operation in a processing system 720 as described herein, the processing system 720 may support techniques for improved communication reliability, enhanced coverage, and improved coordination between devices.

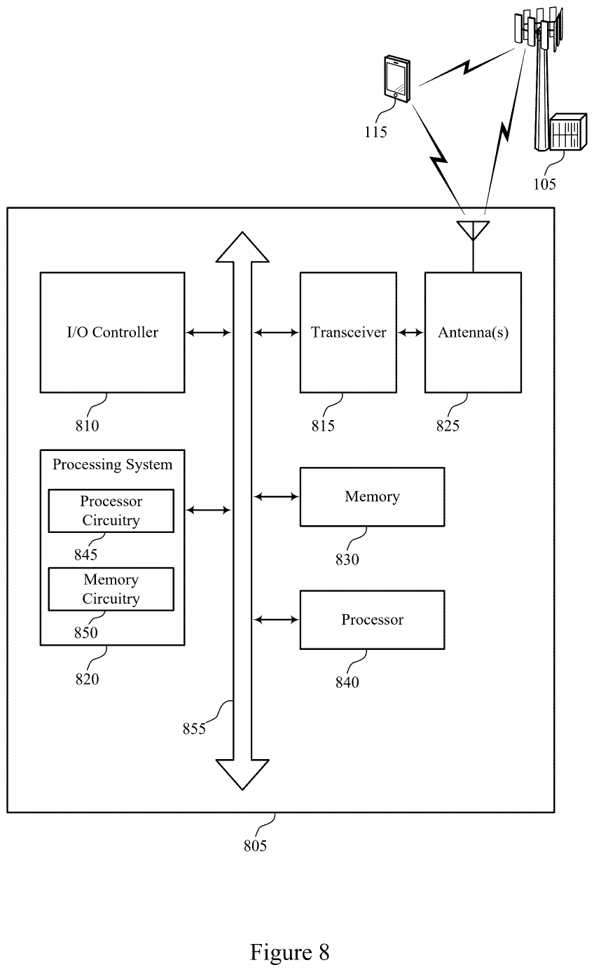

FIG. 8 shows an example of a system including a device 805 that supports rate matching across repetitions for phase jump estimation across gaps. The device 805 may be an example of or include components of UE 115. The device 805 may communicate (such as wirelessly) with one or more other devices (such as network entities 105, UEs 115). The device 805 may include components for transmitting and receiving communication, which may include a processing system 820, an input/output (I/O) controller, such as an I/O controller 810, a transceiver 815, antenna(s) 825, a memory 830, and a processor 840. Components of the device 805 may be coupled (such as operatively, communicatively, functionally, electronically, electrically, in electronic communication) a bus 855.

The transceiver 815 may support bi-directional communication via antenna(s) 825, and may support transmission operations, reception operations, or both, as described herein. The transceiver 815 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 805). The transceiver 815 may modulate symbols and provide the modulated symbols to antenna(s) 825 for transmission, and demodulate symbols from signals received using antenna(s) 825.

The processor 840 may be a general-purpose processing component that supports various operations (such as applications) of the device 805. The memory 830 may be a general-purpose storage component that stores code executable by the processor 840. Such code may include instructions that, when executed by the processor 840, cause the device 805 to perform various functions (such as to support an application of the device 805). The I/O controller 810 may manage inputs and outputs for the device 805, may manage peripherals not integrated into the device 805, or may represent a physical connection (such as port) to an external peripheral. The processor 840 may interact with a modem, a keyboard, a mouse, a touchscreen, or other device (such as via I/O controller 810). In some implementations, a user may interact with the device 805 via the I/O controller 810 or via hardware components controlled by the I/O controller 810.

The processing system 820 may be an example of a processing system 140 or a processing system 720. For example, the processing system 820 may include processor circuitry 845 and memory circuitry 850 that stores code, and may be configured to cause the device 805 to perform operations that support rate matching across repetitions for phase jump estimation across gaps. Although the processing system 820 is illustrated as a separate component, which may involve a separate chip, chipset, or other module, in some implementations, one or more functions described with reference to the processing system 820 may be supported by or performed by a transceiver 815, antenna(s) 825, a processor 840, memory 830, or any combination thereof, such that a processing system 820 may include one or more of a transceiver 815, antenna(s) 825, a processor 840, memory 830, or any combination thereof.

By including or configuring the processing system 820 for operation in the device 805 as described herein, may support techniques for improved communication reliability, enhanced coverage, more efficient utilization of communication resources, and improved coordination between devices.

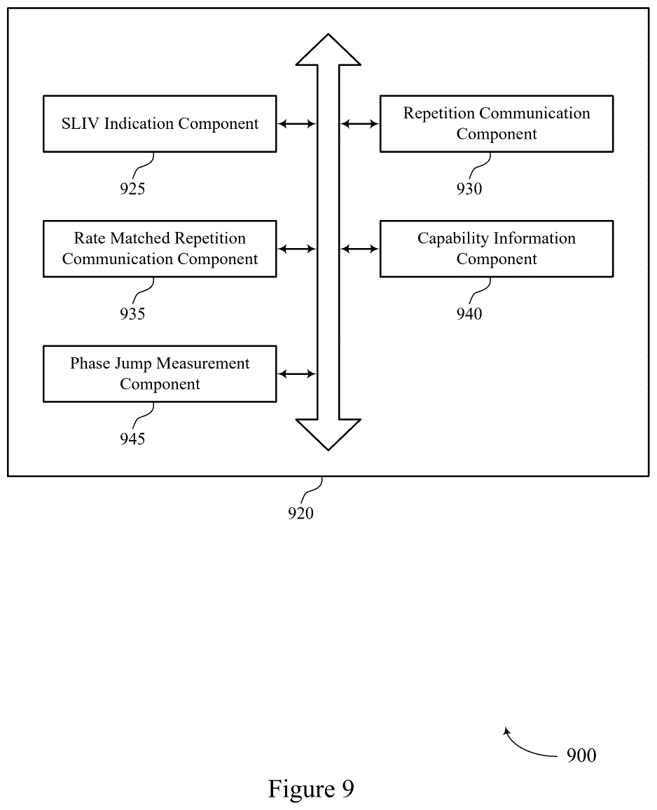

FIG. 9 shows an example 900 of a processing system 920 that supports rate matching across repetitions for phase jump estimation across gaps. A processing system 920 may be an example of a processing system 145 (such as network entity 105) and may include an SLIV indication component 925, a repetition communication component 930, a rate matched repetition communication component 935, a capability information component 940, a phase jump measurement component 945, or any combination thereof. A processing system 920, or various component thereof, may be an example of means for performing (such as a means for causing a network entity 105 to perform) various techniques described herein.

The SLIV indication component 925 may be configured to cause the network entity 105 to transmit DCI including a SLIV that schedules a first set of multiple shared channel resources for repetitions of a shared channel message in accordance with a coverage enhancement mode, the first set of multiple shared channel resources spanning one or more slot boundaries and including at least a first shared channel resource and a second shared channel resource, the first shared channel resource separated from the second shared channel resource by a second set of multiple shared channel resources. The repetition communication component 930 may be configured to cause the network entity 105 to communicate a first repetition of the shared channel message via the first shared channel resource of the first set of multiple shared channel resources in accordance with a first redundancy version. The rate matched repetition communication component 935 may be configured to cause the network entity 105 to communicate a second repetition of the shared channel message via the second shared channel resource of the first set of multiple shared channel resources in accordance with at least a partial rate matching of the first repetition to the second shared channel resource.

In some examples, the first repetition of the shared channel message is rate matched to the second shared channel resource of the first set of multiple shared channel resources, and the second repetition of the shared channel message is in accordance with the first redundancy version.

In some examples, the DCI indicates that the first shared channel resource and the second shared channel resource correspond to the first redundancy version.

In some examples, the capability information component 940 may be configured to cause the network entity 105 to receive capability information of a UE that indicates a threshold quantity of symbols of suspended uplink transmission between two uplink shared channel resources corresponding to the first set of multiple shared channel resources that have phase coherency, where the SLIV is in accordance with the capability information of the UE.

In some examples, the phase jump measurement component 945 may be configured to cause the network entity 105 to measure a phase jump between the first repetition of the shared channel message in the first shared channel resource and the second repetition of the shared channel message in the second shared channel resource in accordance with a comparison of data tones or symbols, or both, of the first repetition and the second repetition.

In some examples, a portion of the first repetition of the shared channel message is rate matched to a beginning portion of the second shared channel resource that corresponds to bit indexes for system bit priority mapping information, and the second repetition of the shared channel message in accordance with a second redundancy version that is different than the first redundancy version.

In some examples, the portion of the first repetition that is rate matched to the beginning portion of the second shared channel resource corresponds to a first quantity of bits of the first repetition, the first quantity of bits being in accordance with a resource block allocation, a modulation and coding scheme, or a quantity of spatial layers, or any combination thereof, used to communicate the first repetition and the second repetition.

In some examples, the rate matched repetition communication component 935 may be configured to cause the network entity 105 to transmit control signaling that indicates a quantity of symbols in the portion of the first redundancy version that is rate matched to the beginning portion of the second repetition of the shared channel message.

In some examples, a second code block order of code blocks of the second repetition is reversed from a first code block order of code blocks of the first repetition in accordance with the portion of the first repetition being rate matched to the beginning portion of the second shared channel resource.

In some examples, the rate matched repetition communication component 935 may be configured to cause the network entity 105 to decode the second repetition of the shared channel message in accordance with at least the partial rate matching of the first repetition to the second shared channel resource, the first set of multiple shared channel resources being uplink shared channel resources.

In some examples, the rate matched repetition communication component 935 may be configured to cause the network entity 105 to rate matching at least a portion of the first repetition to the second share channel resource, the first set of multiple shared channel resources being downlink shared channel resources.

A processing system 920 may include or be an example of one or more chips, SoCs, chipsets, packages, components, or devices that individually or collectively constitute or include a processing system. A processing system 920 may interface with other components of a network entity 105. For example, operations described with reference to a processing system 920, or various components thereof, may be performed by or with other such components, including a receiver, a transmitter, a transceiver, a modem, a user interface, a modulator/demodulator, an encoder/decoder, or any combination thereof (such as of the processing system 920, coupled with the processing system 920, of a network entity 105). Operations described herein with reference to the processing system 920, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 920 for operation in a processing system 920 as described herein, the processing system 920 may support techniques for improved communication reliability, enhanced coverage, more efficient utilization of communication resources, and improved coordination between devices.

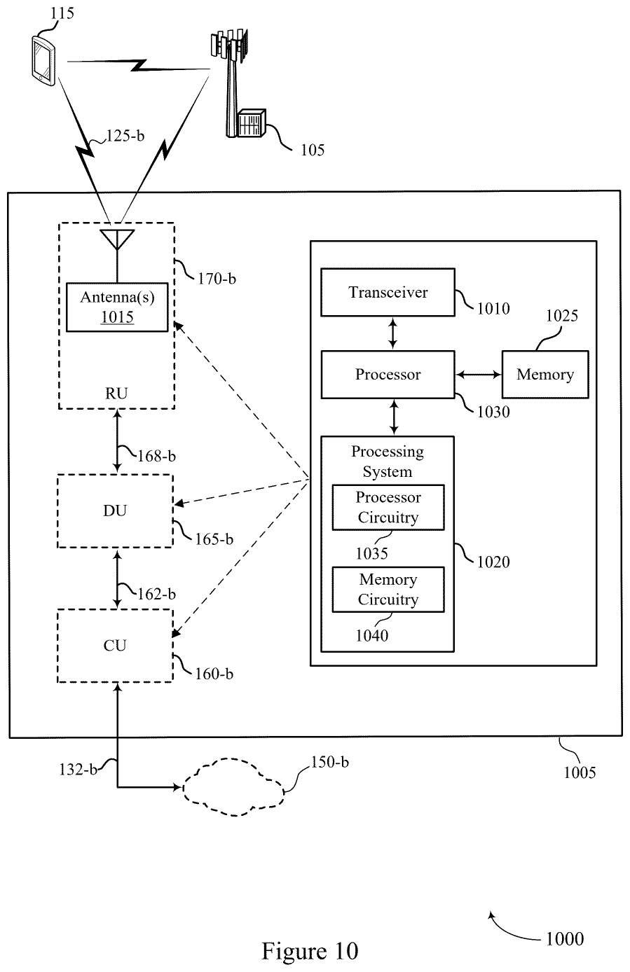

FIG. 10 shows an example of a system 1000 including a device 1005 that supports rate matching across repetitions for phase jump estimation across gaps. The device 1005 may communicate (such as via one or more wired interfaces or one or more wireless interfaces) with other network devices or network equipment such as a core network 150-b, other network entities 105, UEs 115, or any combination thereof. The device 1005 may include components for transmitting and receiving communication, which may include a processing system 1020, a transceiver 1010, antenna(s) 1015, a memory 1025, and a processor 1030. Components of the device 1005 may be coupled (such as operatively, communicatively, functionally, electronically, electrically, in electronic communication) via one or more interfaces.

The transceiver 1010 may communicate bi-directionally with another transceiver via wired or wireless links, and may support transmission operations, reception operations, or both, as described herein. The transceiver 1010 may include a modem to modulate and demodulate signals, to provide the modulated signals for transmission (such as via antenna(s) 1015, via a wired interface), and to demodulate received signals (such as received via antenna(s) 1015, received via a wired interface). The transceiver 1010 may be operable to support communication via one or more communication links (such as a communication link 125-b, a backhaul link 132-b, a midhaul link 162-b, fronthaul link 168-b).

The processor 1030 may be a general-purpose processing component that supports various operations (such as applications) of the device 1005. The memory 1025 may be a general-purpose storage component that stores code executable by the processor 1030. Such code may include instructions that, when executed by the processor 1030, cause the device 1005 to perform various functions (such as to support an application of the device 1005).

For examples in which the device 1005 is a network entity 105 in a disaggregated architecture, one or more components of the device 1005 may be located at one or more of a CU 160-b, a DU 165-b, or an RU 170-b, one or more of which may include aspects of the processing system 1020, the processor 1030, the memory 1025, or the transceiver 1010. Functions of the device 1005 may be performed at different components or an operation may be divided between different components (such as different functions being supported by aspects of the CU 160-b, the DU 165-b, or the RU 170-b, the transceiver 1010, the processor 1030, the memory 1025, the processing system 1020, or any combination thereof). For example, the processing system 1020 may be a component of one or more of the CU 160-b, the DU 165-b, or the RU 170-b. In some examples, interfaces between components of device 1005 (such as CU 160-b, DU 165-b, RU 170-b) may support communication at a protocol layer or between protocol layers of a protocol stack.

In some examples, the processing system 1020 may manage aspects of communication with the core network 150-b (such as via a backhaul link 132). For example, the processing system 1020 may manage the transfer of data communication for UEs 115 with a gateway of the core network 150-b. In some examples, the processing system 1020 may manage communication with one or more other network entities 105 and may include a controller or scheduler for controlling communication with UEs 115 (such as in cooperation with the one or more other network entities 105). In some examples, the processing system 1020 may support an interface (such as X2 interface, Xn interface) to provide communication between network entities 105.

The processing system 1020 may be an example of a processing system 145 or a processing system 920. For example, the processing system 1020 may include processor circuitry 1035 and memory circuitry 1040 that stores code, and the processing system 1020 may be configured to cause the device 1005 to perform operations that support rate matching across repetitions for phase jump estimation across gaps. Although the processing system 1020 is illustrated as a separate component, which may involve a separate chip, chipset, or other module, in some implementations, one or more functions described with reference to the processing system 1020 may be supported by or performed by a transceiver 1010, antenna(s) 1015, a processor 1030, memory 1025, or any combination thereof, such that a processing system 1020 may include one or more of a transceiver 1010, antenna(s) 1015, a processor 1030, memory 1025, or any combination thereof. Further, processor circuitry 1035 and memory circuitry 1040 each may be implemented at the device 1005 in accordance with an aggregated architecture, or the processor circuitry 1035 and the memory circuitry 1040 may be implemented at one or more of a CU 160-b, a DU 165-b, or an RU 170-b in accordance with a disaggregated architecture.

By including or configuring the processing system 1020 for operation in the device 1005 as described herein, may support techniques for improved communication reliability, enhanced coverage, more efficient utilization of communication resources, and improved coordination between devices.

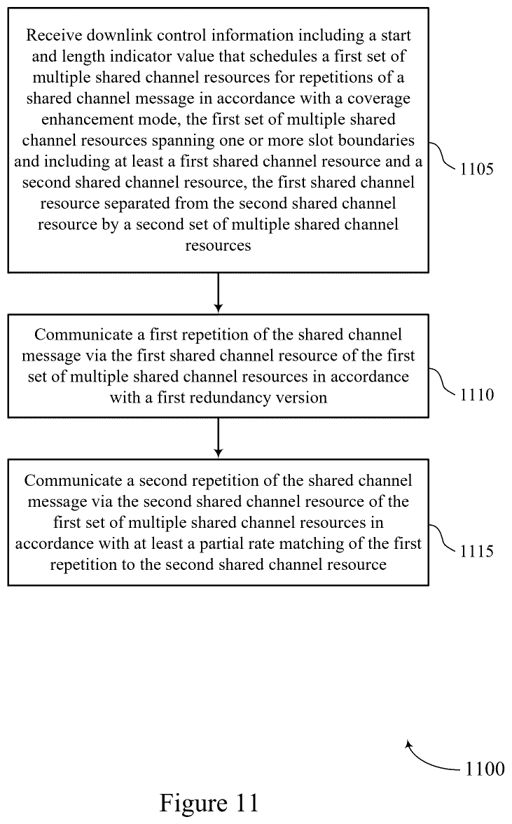

FIG. 11 shows an example of a method 1100 that supports rate matching across repetitions for phase jump estimation across gaps. Operations of the method 1100 may be performed by a UE or its components (such as using a processing system configured to cause the UE 115 to perform one or more of the operations) as described herein.

At 1105, the method may include receiving DCI including a SLIV that schedules a first set of multiple shared channel resources for repetitions of a shared channel message in accordance with a coverage enhancement mode, the first set of multiple shared channel resources spanning one or more slot boundaries and including at least a first shared channel resource and a second shared channel resource, the first shared channel resource separated from the second shared channel resource by a second set of multiple shared channel resources. In some examples, aspects of the operations of 1105 may be performed by an SLIV indication component 725.

At 1110, the method may include communicating a first repetition of the shared channel message via the first shared channel resource of the first set of multiple shared channel resources in accordance with a first redundancy version. In some examples, aspects of the operations of 1110 may be performed by a repetition communication component 730.

At 1115, the method may include communicating a second repetition of the shared channel message via the second shared channel resource of the first set of multiple shared channel resources in accordance with at least a partial rate matching of the first repetition to the second shared channel resource. In some examples, aspects of the operations of 1115 may be performed by a rate matched repetition communication component 735.

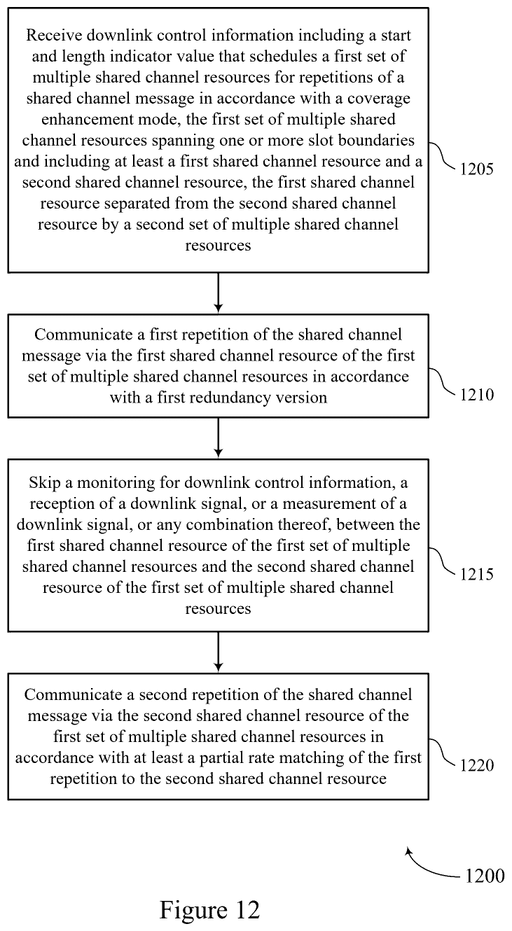

FIG. 12 shows an example of a method 1200 that supports rate matching across repetitions for phase jump estimation across gaps. Operations of the method 1200 may be performed by a UE or its components (such as using a processing system configured to cause the UE 115 to perform one or more of the operations) as described herein.

At 1205, the method may include receiving DCI including a SLIV that schedules a first set of multiple shared channel resources for repetitions of a shared channel message in accordance with a coverage enhancement mode, the first set of multiple shared channel resources spanning one or more slot boundaries and including at least a first shared channel resource and a second shared channel resource, the first shared channel resource separated from the second shared channel resource by a second set of multiple shared channel resources. In some examples, aspects of the operations of 1205 may be performed by an SLIV indication component 725.

At 1210, the method may include communicating a first repetition of the shared channel message via the first shared channel resource of the first set of multiple shared channel resources in accordance with a first redundancy version. In some examples, aspects of the operations of 1210 may be performed by a repetition communication component 730.

At 1215, the method may include skipping a monitoring for DCI, a reception of a downlink signal, or a measurement of a downlink signal, or any combination thereof, between the first shared channel resource of the first set of multiple shared channel resources and the second shared channel resource of the first set of multiple shared channel resources. In some examples, aspects of the operations of 1215 may be performed by an SLIV indication component 725.

At 1220, the method may include communicating a second repetition of the shared channel message via the second shared channel resource of the first set of multiple shared channel resources in accordance with at least a partial rate matching of the first repetition to the second shared channel resource. In some examples, aspects of the operations of 1220 may be performed by a rate matched repetition communication component 735.

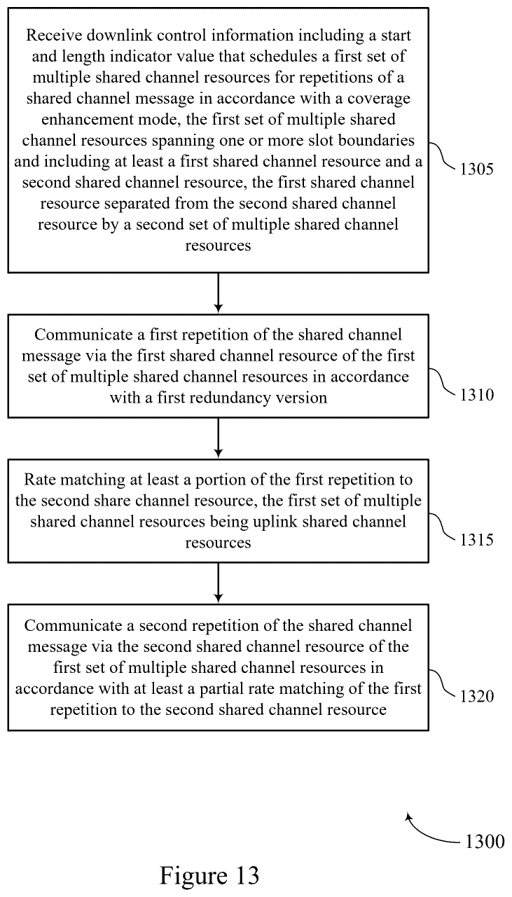

FIG. 13 shows an example of a method 1300 that supports rate matching across repetitions for phase jump estimation across gaps. Operations of the method 1300 may be performed by a UE or its components (such as using a processing system configured to cause the UE 115 to perform one or more of the operations) as described herein.

At 1305, the method may include receiving DCI including a SLIV that schedules a first set of multiple shared channel resources for repetitions of a shared channel message in accordance with a coverage enhancement mode, the first set of multiple shared channel resources spanning one or more slot boundaries and including at least a first shared channel resource and a second shared channel resource, the first shared channel resource separated from the second shared channel resource by a second set of multiple shared channel resources. In some examples, aspects of the operations of 1305 may be performed by an SLIV indication component 725.

At 1310, the method may include communicating a first repetition of the shared channel message via the first shared channel resource of the first set of multiple shared channel resources in accordance with a first redundancy version. In some examples, aspects of the operations of 1310 may be performed by a repetition communication component 730.

At 1315, the method may include rate matching at least a portion of the first repetition to the second shared channel resource, the first set of multiple shared channel resources being uplink shared channel resources. In some examples, aspects of the operations of 1315 may be performed by a rate matched repetition communication component 735.

At 1320, the method may include communicating a second repetition of the shared channel message via the second shared channel resource of the first set of multiple shared channel resources in accordance with at least a partial rate matching of the first repetition to the second shared channel resource. In some examples, aspects of the operations of 1320 may be performed by a rate matched repetition communication component 735.

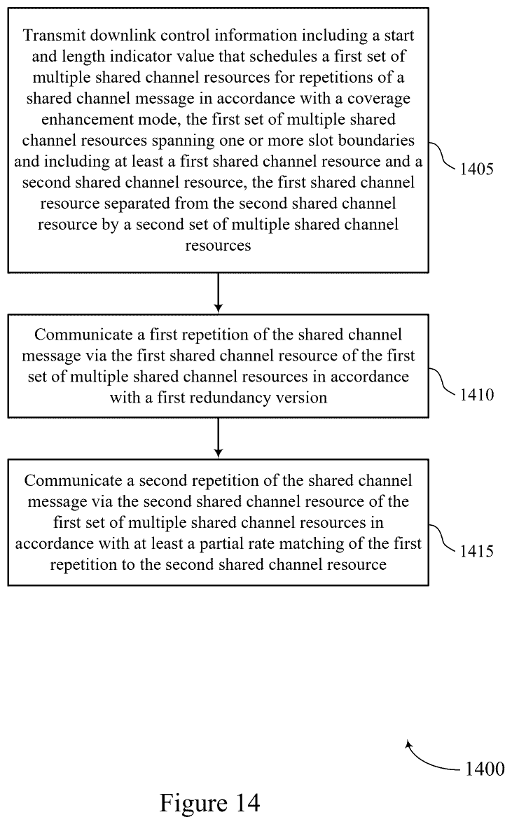

FIG. 14 shows an example of a method 1400 that supports rate matching across repetitions for phase jump estimation across gaps. Operations of the method 1400 may be performed by a network entity 105 or its components (such as using a processing system configured to cause the network entity to perform one or more operations) as described herein.

At 1405, the method may include transmitting DCI including a SLIV that schedules a first set of multiple shared channel resources for repetitions of a shared channel message in accordance with a coverage enhancement mode, the first set of multiple shared channel resources spanning one or more slot boundaries and including at least a first shared channel resource and a second shared channel resource, the first shared channel resource separated from the second shared channel resource by a second set of multiple shared channel resources. In some examples, aspects of the operations of 1405 may be performed by an SLIV indication component 925.

At 1410, the method may include communicating a first repetition of the shared channel message via the first shared channel resource of the first set of multiple shared channel resources in accordance with a first redundancy version. In some examples, aspects of the operations of 1410 may be performed by a repetition communication component 930.

At 1415, the method may include communicating a second repetition of the shared channel message via the second shared channel resource of the first set of multiple shared channel resources in accordance with at least a partial rate matching of the first repetition to the second shared channel resource. In some examples, aspects of the operations of 1415 may be performed by a rate matched repetition communication component 935.

Implementation examples are described in the following numbered clauses:

Aspect 1: A method for wireless communications at a UE, comprising: receiving DCI comprising a SLIV that schedules a first plurality of shared channel resources for repetitions of a shared channel message in accordance with a coverage enhancement mode, the first plurality of shared channel resources spanning one or more slot boundaries and comprising at least a first shared channel resource and a second shared channel resource, the first shared channel resource separated from the second shared channel resource by a second plurality of shared channel resources; communicating a first repetition of the shared channel message via the first shared channel resource of the first plurality of shared channel resources in accordance with a first redundancy version; and communicating a second repetition of the shared channel message via the second shared channel resource of the first plurality of shared channel resources in accordance with at least a partial rate matching of the first repetition to the second shared channel resource.

Aspect 2: The method of aspect 1, wherein the first repetition of the shared channel message is rate matched to the second shared channel resource of the first plurality of shared channel resources, and the second repetition of the shared channel message is in accordance with the first redundancy version.

Aspect 3: The method of any of aspects 1 through 2, wherein the DCI indicates that the first shared channel resource and the second shared channel resource correspond to the first redundancy version.

Aspect 4: The method of any of aspects 1 through 3, further comprising: performing a phase jump measurement between the first repetition and the second repetition that skips one or more tones in accordance with the one or more tones being punctured by one or more channel state information reference signals in the first repetition or the second repetition.

Aspect 5: The method of any of aspects 1 through 4, further comprising: skipping a monitoring for DCI, a reception of a downlink signal, or a measurement of a downlink signal, or any combination thereof, between the first shared channel resource of the first plurality of shared channel resources and the second shared channel resource of the first plurality of shared channel resources.

Aspect 6: The method of any of aspects 1 through 5, further comprising: transmitting capability information of the UE that indicates a threshold quantity of symbols of suspended uplink transmission between two uplink shared channel resources corresponding to the first plurality of shared channel resources that have phase coherency, wherein the SLIV is in accordance with the capability information of the UE.

Aspect 7: The method of any of aspects 1 through 6, wherein a portion of the first repetition of the shared channel message is rate matched to a beginning portion of the second shared channel resource that corresponds to bit indexes for system bit priority mapping information, and the second repetition of the shared channel message is in accordance with a second redundancy version that is different than the first redundancy version.

Aspect 8: The method of aspect 7, wherein the portion of the first repetition that is rate matched to the beginning portion of the second shared channel resource corresponds to a first quantity of bits of the first repetition, the first quantity of bits being in accordance with a resource block allocation, a modulation and coding scheme, or a quantity of spatial layers, or any combination thereof, used to communicate the first repetition and the second repetition.

Aspect 9: The method of any of aspects 7 through 8, further comprising: receiving control signaling that indicates a quantity of symbols in the portion of the first redundancy version that is rate matched to the beginning portion of the second repetition of the shared channel message.

Aspect 10: The method of any of aspects 7 through 9, wherein a second code block order of code blocks of the second repetition is reversed from a first code block order of code blocks of the first repetition in accordance with the portion of the first repetition being rate matched to the beginning portion of the second shared channel resource.

Aspect 11: The method of any of aspects 1 through 10, further comprising: decoding the second repetition of the shared channel message in accordance with at least the partial rate matching of the first repetition to the second shared channel resource, the first plurality of shared channel resources being downlink shared channel resources.

Aspect 12: The method of any of aspects 1 through 11, further comprising: rate matching at least a portion of the first repetition to the second shared channel resource, the first plurality of shared channel resources being uplink shared channel resources.

Aspect 13: The method of any of aspects 1 through 12, further comprising: receiving a control signal that configures the UE for a coverage enhancement mode, the SLIV scheduling the first plurality of shared channel resources in accordance with the coverage enhancement mode.

Aspect 14: A method for wireless communications at a network entity, comprising: transmitting DCI comprising a SLIV that schedules a first plurality of shared channel resources for repetitions of a shared channel message in accordance with a coverage enhancement mode, the first plurality of shared channel resources spanning one or more slot boundaries and comprising at least a first shared channel resource and a second shared channel resource, the first shared channel resource separated from the second shared channel resource by a second plurality of shared channel resources; communicating a first repetition of the shared channel message via the first shared channel resource of the first plurality of shared channel resources in accordance with a first redundancy version; and communicating a second repetition of the shared channel message via the second shared channel resource of the first plurality of shared channel resources in accordance with at least a partial rate matching of the first repetition to the second shared channel resource.

Aspect 15: The method of aspect 14, wherein the first repetition of the shared channel message is rate matched to the second shared channel resource of the first plurality of shared channel resources, and the second repetition of the shared channel message is in accordance with the first redundancy version.

Aspect 16: The method of any of aspects 14 through 15, wherein the DCI indicates that the first shared channel resource and the second shared channel resource correspond to the first redundancy version.

Aspect 17: The method of any of aspects 14 through 16, further comprising: receiving capability information of a UE that indicates a threshold quantity of symbols of suspended uplink transmission between two uplink shared channel resources corresponding to the first plurality of shared channel resources that have phase coherency, wherein the SLIV is in accordance with the capability information of the UE.

Aspect 18: The method of any of aspects 14 through 17, further comprising: measuring a phase jump between the first repetition of the shared channel message in the first shared channel resource and the second repetition of the shared channel message in the second shared channel resource in accordance with a comparison of data tones or symbols, or both, of the first repetition and the second repetition.

Aspect 19: The method of any of aspects 14 through 18, wherein a portion of the first repetition of the shared channel message is rate matched to a beginning portion of the second shared channel resource that corresponds to bit indexes for system bit priority mapping information, and the second repetition of the shared channel message in accordance with a second redundancy version that is different than the first redundancy version.

Aspect 20: The method of aspect 19, wherein the portion of the first repetition that is rate matched to the beginning portion of the second shared channel resource corresponds to a first quantity of bits of the first repetition, the first quantity of bits being in accordance with a resource block allocation, a modulation and coding scheme, or a quantity of spatial layers, or any combination thereof, used to communicate the first repetition and the second repetition.

Aspect 21: The method of any of aspects 19 through 20, further comprising: transmitting control signaling that indicates a quantity of symbols in the portion of the first redundancy version that is rate matched to the beginning portion of the second repetition of the shared channel message.

Aspect 22: The method of any of aspects 19 through 21, wherein a second code block order of code blocks of the second repetition is reversed from a first code block order of code blocks of the first repetition in accordance with the portion of the first repetition being rate matched to the beginning portion of the second shared channel resource.

Aspect 23: The method of any of aspects 14 through 22, further comprising: decoding the second repetition of the shared channel message in accordance with at least the partial rate matching of the first repetition to the second shared channel resource, the first plurality of shared channel resources being uplink shared channel resources.

Aspect 24: The method of any of aspects 14 through 23, further comprising: rate matching at least a portion of the first repetition to the second shared channel resource, the first plurality of shared channel resources being downlink shared channel resources.

Aspect 25: A UE for wireless communications, comprising a processing system that includes processor circuitry and memory circuitry that stores code, the processing system configured to cause the UE to perform a method of any of aspects 1 through 13.

Aspect 26: A UE for wireless communications, comprising at least one means for performing a method of any of aspects 1 through 13.

Aspect 27: A non-transitory computer-readable medium storing code for wireless communications, the code comprising instructions executable by one or more processors to perform a method of any of aspects 1 through 13.

Aspect 28: A network entity for wireless communications, comprising a processing system that includes processor circuitry and memory circuitry that stores code, the processing system configured to cause the network entity to perform a method of any of aspects 14 through 24.

Aspect 29: A network entity for wireless communications, comprising at least one means for performing a method of any of aspects 14 through 24.

Aspect 30: A non-transitory computer-readable medium storing code for wireless communications, the code comprising instructions executable by one or more processors to perform a method of any of aspects 14 through 24.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
receive downlink control information comprising a start and length indicator value that schedules a plurality of uplink shared channel resources for repetitions of an uplink shared channel message, the plurality of uplink shared channel resources spanning one or more slot boundaries and comprising at least a first uplink shared channel resource and a second uplink shared channel resource, the first uplink shared channel resource separated from the second uplink shared channel resource by one or more downlink shared channel resources;
transmit a first repetition of the uplink shared channel message via the first uplink shared channel resource in accordance with a first redundancy version; and
transmit a second repetition of the uplink shared channel message via the second uplink shared channel resource in accordance with at least a partial rate matching of the first repetition to the second uplink shared channel resource.

2. The UE of claim 1, wherein the first repetition of the uplink shared channel message is rate matched to the second uplink shared channel resource of the plurality of uplink shared channel resources, and the second repetition of the uplink shared channel message is in accordance with the first redundancy version.

3. The UE of claim 1, wherein the downlink control information indicates that the first uplink shared channel resource and the second uplink shared channel resource correspond to the first redundancy version.

4. The UE of claim 1, wherein the processing system is further configured to cause the UE to:
skip a monitoring for downlink control information, a reception of a downlink signal, or a measurement of a downlink signal, or any combination thereof, between the first uplink shared channel resource and the second uplink shared channel resource.

5. The UE of claim 1, wherein the processing system is further configured to cause the UE to:
transmit capability information of the UE that indicates a threshold quantity of symbols of suspended uplink transmission between two uplink shared channel resources corresponding to the plurality of uplink shared channel resources that have phase coherency, wherein the start and length indicator value is in accordance with the capability information of the UE.

6. The UE of claim 1, wherein a portion of the first repetition of the uplink shared channel message is rate matched to a beginning portion of the second uplink shared channel resource that corresponds to bit indexes for system bit priority mapping information, and the second repetition of the uplink shared channel message is in accordance with a second redundancy version that is different than the first redundancy version.

7. The UE of claim 6, wherein the portion of the first repetition that is rate matched to the beginning portion of the second uplink shared channel resource corresponds to a first quantity of bits of the first repetition, the first quantity of bits being in accordance with a resource block allocation, a modulation and coding scheme, or a quantity of spatial layers, or any combination thereof, used to communicate the first repetition and the second repetition.

8. The UE of claim 6, wherein the processing system is further configured to cause the UE to:
receive control signaling that indicates a quantity of symbols in the portion of the first redundancy version that is rate matched to the beginning portion of the second repetition of the uplink shared channel message.

9. The UE of claim 6, wherein a second code block order of code blocks of the second repetition is reversed from a first code block order of code blocks of the first repetition in accordance with the portion of the first repetition being rate matched to the beginning portion of the second uplink shared channel resource.

10. The UE of claim 1, wherein the processing system is further configured to cause the UE to:
receive a control signal that configures the UE for a coverage enhancement mode, the start and length indicator value scheduling the plurality of uplink shared channel resources in accordance with the coverage enhancement mode.

11. A network entity, comprising:
a processing system that includes processor circuitry and memory circuitry that stores code, the processing system configured to cause the network entity to:
transmit downlink control information comprising a start and length indicator value that schedules a plurality of uplink shared channel resources for repetitions of an uplink shared channel message, the plurality of uplink shared channel resources spanning one or more slot boundaries and comprising at least a first uplink shared channel resource and a second uplink shared channel resource, the first uplink shared channel resource separated from the second uplink shared channel resource by one or more downlink shared channel resources;
receive a first repetition of the uplink shared channel message via the first uplink shared channel resource of the plurality of uplink shared channel resources in accordance with a first redundancy version; and
receive a second repetition of the uplink shared channel message via the second uplink shared channel resource of the plurality of uplink shared channel resources in accordance with at least a partial rate matching of the first repetition to the second uplink shared channel resource.

12. The network entity of claim 11, wherein the first repetition of the uplink shared channel message is rate matched to the second uplink shared channel resource of the plurality of uplink shared channel resources, and the second repetition of the uplink shared channel message is in accordance with the first redundancy version.

13. The network entity of claim 11, wherein the processing system is further configured to cause the network entity to:
receive capability information of a user equipment (UE) that indicates a threshold quantity of symbols of suspended uplink transmission between two uplink shared channel resources corresponding to the plurality of uplink shared channel resources that have phase coherency, wherein the start and length indicator value is in accordance with the capability information of the UE.

14. The network entity of claim 11, wherein the processing system is further configured to cause the network entity to:
measure a phase jump between the first repetition of the uplink shared channel message in the first uplink shared channel resource and the second repetition of the uplink shared channel message in the second uplink shared channel resource in accordance with a comparison of data tones or symbols, or both, of the first repetition and the second repetition.

15. The network entity of claim 11, wherein the processing system is further configured to cause the network entity to:
perform a phase jump measurement between the first repetition and the second repetition that skips one or more tones in accordance with the one or more tones being punctured by one or more channel state information reference signals in the first repetition or the second repetition.

16. The network entity of claim 11, wherein the processing system is further configured to cause the network entity to:
decode the second repetition of the uplink shared channel message in accordance with at least the partial rate matching of the first repetition to the second uplink shared channel resource.

17. The network entity of claim 11, wherein a portion of the first repetition of the uplink shared channel message is rate matched to a beginning portion of the second uplink shared channel resource that corresponds to bit indexes for system bit priority mapping information, and the second repetition of the uplink shared channel message in accordance with a second redundancy version that is different than the first redundancy version.

18. The network entity of claim 17, wherein a second code block order of code blocks of the second repetition is reversed from a first code block order of code blocks of the first repetition in accordance with the portion of the first repetition being rate matched to the beginning portion of the second uplink shared channel resource.

19. The network entity of claim 11, wherein the processing system is further configured to cause the network entity to:
transmit a control signal that configures a user equipment (UE) for a coverage enhancement mode, the start and length indicator value scheduling the plurality of uplink shared channel resources in accordance with the coverage enhancement mode.

20. A method for wireless communications at a user equipment (UE), comprising:
receiving downlink control information comprising a start and length indicator value that schedules a plurality of uplink shared channel resources for repetitions of an uplink shared channel message, the plurality of uplink shared channel resources spanning one or more slot boundaries and comprising at least a first uplink shared channel resource and a second uplink shared channel resource, the first uplink shared channel resource separated from the second uplink shared channel resource by one or more downlink shared channel resources;
transmitting a first repetition of the uplink shared channel message via the first uplink shared channel resource in accordance with a first redundancy version; and
communicating a second repetition of the uplink shared channel message via the second uplink shared channel resource in accordance with at least a partial rate matching of the first repetition to the second uplink shared channel resource.
